(19) United States
(12) Patent Application Publication
(10) Pub. No.: US 2026/0131249 A1
(43) Pub. Date: May 14, 2026

(54) CONTROL METHOD, STORAGE MEDIUM AND GAME CONTROL APPARATUS

(71) Applicant: KONAMI DIGITAL ENTERTAINMENT CO., LTD., Tokyo (JP)

(72) Inventors: Akihiko SHIMIZU, Tokyo (JP); Takanori KURODA, Tokyo (JP); Keisuke KAMOGASHIRA, Tokyo (JP); Taichi ISHIOKA, Tokyo (JP); Taku KONISHI, Tokyo (JP); Makoto OMORI, Tokyo (JP)

(73) Assignee: KONAMI DIGITAL ENTERTAINMENT CO., LTD., Tokyo (JP)

(21) Appl. No.: 19/444,446

(22) Filed: Jan. 9, 2026

Related U.S. Application Data
(63) Continuation of application No. PCT/JP2024/025634, filed on Jul. 17, 2024.

(30) Foreign Application Priority Data
Jul. 31, 2023 (JP) 2023-124818

(51) Int. Cl. A63F 13/67

(52) U.S. Cl. CPC A63F 13/67

(57) ABSTRACT

A game system for executing a control of a game for training of a training target by changing or setting a parameter of the training target based on a user's operation, includes a first parameter management unit and a game execution unit. The first parameter management unit manages a first parameter necessary for an execution of the game for training the training target, that is associated with a user identification information of the user. The game executing unit executes the game for training the training target on a condition that a required amount of the first parameter is consumed at least at one consumption timing set after a beginning of the training for the training target.

### CROSS-REFERENCE TO RELATED APPLICATIONS

This application is a Continuation of International Application No. PCT/JP2024/025634, filed Jul. 17, 2024 in the Japanese Patent Office, which is based upon and claims the benefit of priority of the prior Japanese Patent Application 2023-124818, filed on Jul. 31, 2023, the entire contents of which are incorporated herein by reference.

### BACKGROUND ART

### Field of Invention

The present invention relates to a program, a game control apparatus, a game system, a control method and a storage medium.

### Description of Related Art

Conventionally, a game for training a character by a user is known (for example, Japanese Patent Application Laid-Open Publication No. JP 2021-058809). In some training games, the game is executed by consuming a predetermined amount of points when starting to train a single character.

Regarding the points required to start training a character, even if they are consumed, they may recover over time, or can be instantly restored by the user using a paid item. However, in the case of restoring the required points as consumed over time, the user needs to wait until the shortage of the points is restored. For this reason, it may take a long time before the game can be started, and the user may feel a burden. Further, the user's desire to start the game may be reduced, which could lead to user's abandoning games. Also, in the case where required points for starting the training is restored by using the paid item, since it is necessary to enough charge to cover the shortage, burden on the user may increase. Consequently, in this case also the user's desire to start the game may fade.

### SUMMARY

Therefore, one of the objects of the present invention is to reduce a burden on a user for executing a game.

A control method in one aspect of the present invention which controls a game for training a training target by changing or setting a parameter of the training target based on a user's operation, includes:
managing a first parameter necessary for an execution of the game for training the training target, the first parameter being associated with a user identification information of the user; and
executing the game for training the training target on a condition that a required amount of the first parameter is consumed at least at one consumption timing set after a beginning of a training of the training target.

A non-transitory computer-readable storage medium in one aspect of the present invention having recorded therein a program that is executed by a processor of an information processing apparatus and is for a control of a game for training a training target by changing or setting a parameter of the training target based on a user's operation, the program causes the processor to:
manage a first parameter necessary for an execution of the game for training the training target, the first parameter being associated with the user identification information of the user; and
execute the game for training the training target on a condition that a required amount of the first parameter is consumed at least at one consumption timing set after a beginning of a training of the training target.

A game control apparatus in one aspect of the present invention including at least one processor, and a memory that cooperates with the processor and stores instructions to be executed by the processor, that controls a game for training a training target by changing or setting a parameter of the training target based on a user's operation, and that, when the instructions are executed by the processor, causes the processor to:
manage a first parameter necessary for an execution of the game for training the training target, the first parameter being associated with a user identification information of the user; and
execute the game for training the training target on a condition that a required amount of the first parameter is consumed at least at one consumption timing set after a beginning of a training of the training target.

The object, characteristics and advantages of the present invention become more apparent by the detailed explanation and the accompanying drawings below.

### BRIEF DESCRIPTION OF THE DRAWINGS

FIG. 1 is a block diagram schematically illustrating an example of a configuration of a game system according to one embodiment of the present invention.

FIG. 2 is a diagram illustrating an example of a new member screen.

FIG. 3 is a diagram illustrating an example of a scholarship student selection screen.

FIG. 4 is a diagram illustrating an example of a general enrollment student selection screen.

FIG. 5 is a diagram illustrating an example of a progress screen.

FIG. 6 is a diagram illustrating an example of a panel information table.

FIG. 7 is a diagram illustrating an example of an information table.

FIG. 8 is a diagram illustrating an example of an individual practice instruction screen.

FIG. 9 is a diagram illustrating an example of a practice selection screen.

FIG. 10 is a diagram illustrating an example of an individual practice instruction screen.

FIG. 11 is a diagram illustrating an example of a practice selection screen for a selected group of players.

FIG. 12 is a diagram illustrating an example of a scout destination selection screen.

FIG. 13 is a diagram illustrating an example of a scout player selection screen.

FIG. 14 is a diagram illustrating an example of an insufficient action point notification window.

FIG. 15 is a schematic functional block diagram illustrating one example of a functional configuration of a game system.

FIG. 16 is a diagram illustrating an example of a user information table.

FIG. 17 is a diagram illustrating an example of a character information table.

FIG. 18 is a diagram illustrating an example of a team data.

FIG. 19 is a schematic functional block diagram illustrating another example of a functional configuration of a game system.

FIG. 20 is a flowchart illustrating one example of a processing performed by a game system.

FIG. 21 is a flowchart illustrating one example of a processing performed by a game system.

FIG. 22 is a flowchart illustrating one example of a processing performed by a game system.

FIG. 23 is a flowchart illustrating one example of a processing performed by a game system.

FIG. 24 is a flowchart illustrating one example of a processing performed by a game system.

FIG. 25 is a flowchart illustrating one example of a processing performed by a game system.

### MODES FOR CARRYING OUT THE INVENTION

Hereinafter, one example embodiment of the present invention will be described with reference to drawings.

### 1. Configuration of Game System

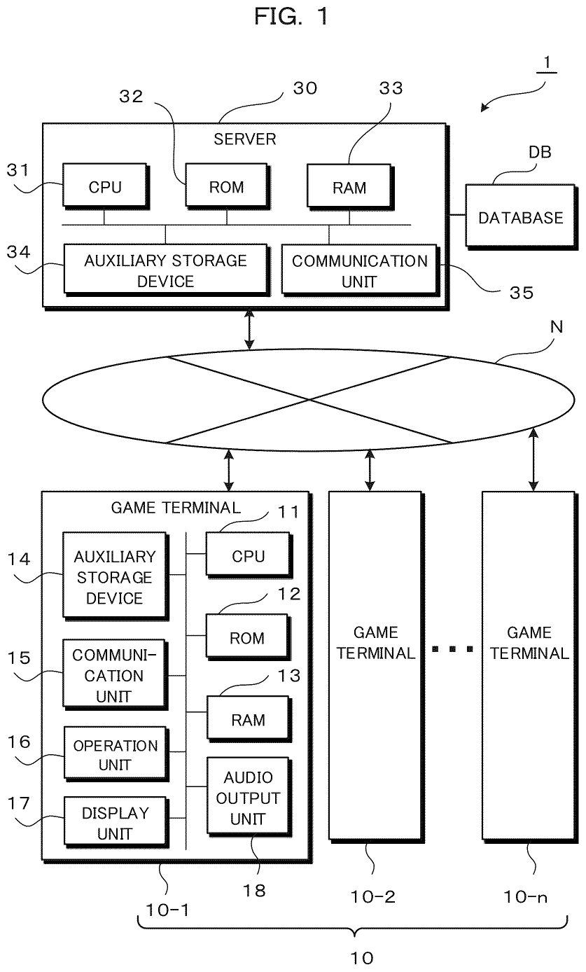

FIG. 1 is a schematic block diagram illustrating an example configuration of a game system 1 according to one embodiment of the present invention. The game system 1 includes a plurality of game terminals 10-n (n is a positive integer, 10-1, 10-2, . . . ) and a server 30. The game terminals 10-n and the server 30 in the game system 1 are communicably connected to each other via a network N such as the Internet. Here, since the plurality of game terminals 10-n have the same configuration, the plurality of game terminals 10-n are simply described as the “game terminal 10” when not particularly distinguished.

The network N according to the present embodiment is not limited to the Internet, and as long as the game terminal 10-n and the server 30 in the game system 1 can be communicably connected to each other, for example, a dedicated line, a public line (such as a telephone line, a mobile communication line, etc.), a wired LAN (Local Area Network), a wireless LAN, or the like may be adopted, or any of the above combined with the Internet may be adopted.

The game terminal 10 to be operated by a user is a computer that the user uses to play a game. The game terminal 10 is, for example, a home game machine (stationary or portable), a personal computer, a smartphone, a mobile phone terminal, a PHS (Personal Handy-phone System) terminal, a personal digital assistant (PDA), a tablet computer, a multi-functional television receiver (so-called smart television), a commercial-use game machine installed in amusement facilities, etc., and the like.

The server 30 is, for example, a server computer. The server 30 stores, for example, the information about the user's game in association with the user ID that uniquely identifies each user in a database DB, and manages the information. The database DB may be constructed in the server 30, or may be constructed in a server computer different from the server 30.

In the game system 1, it is possible to play against a computer (also called a CPU match) and communication match. In the communication match, for example, a user A who operates a game terminal 10-1 and a user B who operates a game terminal 10-2 can play a match game via the network N. In the case of this communication match, for example, there is a method of directly communicating and playing between the game terminal 10-1 and the game terminal 10-2 matched by the server 30 by P2P (Peer to Peer) connection or the like. Alternatively, there is also a method of playing a communication match by communicating data between the game terminal 10-1 and the game terminal 10-2 via the server 30. The communication match may be performed in any method.

The communication between the game terminal 10-n and the server 30 uses HTTP (Hyper Text Transfer Protocol) operating on TCP/IP (Transmission Control Protocol/Internet Protocol) as the base protocol, and can be realized by implementing an application protocol specified in this system on an upper level.

On the other hand, the communication between the game terminal 10-1 and the game terminal 10-2 connected by P2P or the like can be realized, for example, by a UDP (User Datagram Protocol) which is a communication protocol on a transport layer of an OSI reference model, and which is mainly implemented on the IP protocol. Since the above UDP is a communication method that does not confirm the delivery of data or correct errors, but leaves the data sent to the game terminal on the other side, it has the advantage of low data reliability but high data transfer speed. Of course, it is also possible to use other existing protocols other than UDP for communication between the game terminal 10-1 and the game terminal 10-2, or to use a new protocol newly defined in the future.

Further, for example, in the game terminal 10-n having a short-range wireless communication function using a predetermined frequency band (for example, a frequency band of 2.4 GHz), a plurality of game terminals 10-n can be directly communicated to execute a match game.

### (Hardware Configuration of Game Terminal)

The game terminal 1 mainly comprises a CPU (Central Processing Unit) 11, a ROM (Read Only Memory) 12, a RAM (Random Access Memory) 13, an auxiliary storage device 14, a communication unit 15, an operation unit 16, a display unit 17, and an audio output unit 18, and these components are mutually connected via a bus line including an address bus, a data bus, a control bus and the like. Note that an interface circuit, an image processing unit, a sound processing unit, or the like are interposed between the bus line and the respective constituent elements as necessary, but the illustration thereof is omitted in the drawing.

The CPU 11 interprets and executes the instructions of the game program and controls the entire game terminal 10. The ROM 12 stores programs, data, and the like necessary for basic operation control of the game terminal 10. The RAM 13 stores various programs and data, and secures a work area for the CPU 11.

The auxiliary storage device 14 is a storage device for storing a game program, various data, and the like. As the auxiliary storage device 14, for example, a non-volatile semiconductor memory, a hard disk drive, a solid-state drive, or the like can be used.

The communication unit 15 includes a communication interface (not shown) and has a communication control function for data communication while a game is being executed. Here, the communication control function for data communication includes, for example, an Internet connection function, a wireless LAN (Local Area Network) connection function, and a short-range wireless communication function using a predetermined frequency band (for example, a 2.4 GHz frequency band). The communication unit 15 transmits a connection signal for connecting the game terminal 10 to the network N based on an instruction from the CPU 11, and receives information transmitted from the communication partner side and supplies it to the CPU 11.

The operation unit 16 is provided for a user to input various operation commands to the game terminal 10. Examples of the operation unit 16 include a position input unit (a component of a touch panel) having a touch interface, physical buttons, a controller, an analog stick, a keyboard, a pointing device, and the like. Further, the operation unit 16 may have a voice input function by identifying a voice input from the audio input unit such as a microphone.

The display unit 17 is driven based on an image display command from the CPU 11 and displays a game screen, etc. Various known display devices such as liquid crystal displays and organic EL (Electro-Luminescence) displays can be applied to the display unit 17. Further, the display unit 17 can be a touch panel that combines a display device such as a liquid crystal display with a position input unit equipped with a touch interface. When the display unit 17 is configured as a touch panel, the game terminal 10 includes a touch input detection unit (not shown). When an indicator such as a finger or a pen, etc., comes into contact the screen, the touch input detection unit detects contact position coordinates on the screen and supplies a coordinate signal to the CPU 11. In this way, the contact position on the screen of the display unit 17 is recognized by the CPU 11. It is not necessarily that the display unit 17 is integrated with the game terminal 10, and may be, for example, a television monitor externally connected to the game terminal 10. Thus, in the case of the television monitor or the like to which the display unit 17 is externally connected, the display unit 17 is not included in the configuration of the game terminal 10.

The audio output unit 18 generates an analog audio signal based on a pronunciation instruction from the CPU 11 and outputs an audio or the like from a speaker.

The game terminal 10 may include a recording media drive. Examples of the recording media drive include a DVD-ROM drive, a CD-ROM drive, a hard disk drive, an optical disc drive, a flexible disk drive, a silicon disk drive, a cassette media reader, and the like. In this case, a DVD-ROM, a CD-ROM, a hard disk, an optical disc, a flexible disk, a semiconductor memory, or the like may be used as the storage medium. The recording media drive reads image data, audio data, and program data from the recording medium, and supplies the read data to the RAM 13 or the like via a decoder.

### (Hardware Configuration of Server)

The server 30 mainly includes a CPU 31, a ROM 32, a RAM 33, an auxiliary storage device 34, and a communication unit 35, which are interconnected via bus lines including an address bus, a data bus, a control bus, and the like. Further, an interface circuit is interposed between the bus line and each component as necessary. However, the illustration of the interface circuit is omitted here.

The CPU 31 interprets and executes commands of the system software and the application software to overall control the server 30. The ROM 32 stores a program necessary for basic operation control of the server 30. The RAM 33 stores various programs and data, and secures a working area for the CPU 31. The auxiliary storage device 34 is a storage device for storing programs, various data, and the like. As the auxiliary storage device 34, for example, a hard disk drive or a solid-state drive can be used.

The communication unit 35 includes a communication interface (not shown) and controls communication between each game terminal 10-n via the network N. Further, the communication unit 35 also controls communication with other servers not shown connected to the network N. For example, in the case of a system configuration wherein the server 30 is integrated with the social networking service (SNS), the communication unit 35 of the server 30 controls the communication with the SNS server. Further, for example, the server 30 controls the communication with a video distribution server that distributes a game video played by a user to spectators. Note that the server 30 can also have a video distribution function.

The server 30 can be configured by a single computer, but it can also be configured as a functionally distributed configuration in which each function of the server 30 is distributed to a plurality of servers. Alternatively, a load-balanced server may be adopted by providing a plurality of servers 30 on the network N to provide redundancy (multiplexing). Further, the server 30 may be configured as a cloud server using cloud computing technology.

The program or the data is supplied to the game terminal 10 or the server 30 from a remote location via the network N and is stored in the RAM 13, the auxiliary storage device 14, the RAM 33 or the auxiliary storage device 34. A component (for example, an optical disc drive or a memory card slot, etc.) for reading programs and data stored on an information storage medium (for example, an optical disc or a memory card slot, etc.) may be provided in the game terminal 10 or the server 30. Then, the program or data may be supplied to the game terminal 10 or the server 30 via the information storage medium.

### 2. Outline of Example of Game

The outline of an example of the game will be described below.

In the game system 1, various games can be executed. For example, various games can be played regardless of game format or genre, such as sports games (games based on baseball, soccer, or other sports), racing games, combat games, fighting games, etc. A game may be executed such that the game terminal 10 performs data communication with the server 30 or other game terminal 10, or may be executed by the game terminal 10 alone. In the following, a game based on baseball will be described as one example of the game to be executed on the game system 1, and other games than the baseball game will be mentioned as necessary.

The baseball game according to the present embodiment has a game mode called a training mode in which a baseball team (an example of the group), consisting of a plurality of player characters (hereinafter referred to simply as “players”) as an example of a plurality of affiliated objects, is trained on a team basis. In this training mode, practice, matches, and various other events are executed.

In this baseball game, shown is an example wherein the user becomes a manager of a high school baseball team, and instructs players belonging to the team (members of the baseball team) to practice, etc., to train the plurality of players basically on the team basis. For example, the user trains the plurality of players belonging to the team while aiming for the team's national championship (winning the national high school tournament) and entering a professional baseball team from the manager's point of view.

Further, the user (or the manager character as a user's alter ego) can instruct not only on the team basis but also individual players belonging to the team on the individual basis.

After the training starts, at a predetermined timing (for example, after a specific event occurs on September 6th of in-game time) in the game's virtual time (hereinafter referred to as “in-game time”), the training of that year's team is complete, and the team at that time can be stored in association with the user identification information. In other words, the user can register the team that has trained every year in-game time. The details will be described later.

In the following, the description on dates refers to the dates in-game time if not particularly mentioned that it is in real-world time.

Similarly, every year of in-game time, at a predetermined timing (for example, after the end of a specific event held on October 26th), at least some of the 3^{rd} year players in the team can be stored individually in association with the user identification information. The details will be described later.

Typically, at the start of the training game for a single training target, a considerable amount of points or similar is required as a cost to play the game. For this reason, if the user does not have a sufficient amount of points, the game cannot be started.

In contrast, in the training mode of the present embodiment, points, etc. are not required at the start timing of training. Instead, the points are consumed as costs at the consumption timing set after the start of training. In this way, even when the user does not have enough points at the start timing of training, it is possible to start the training game and to progress the game at least to some extent. It is therefore possible to reduce the burden on the user to run the game (especially to start the game). The consumption timing set after the start of training can be any of at least one timing set from the start to the completion of training, at a timing the training is complete, or at least one timing set after the training is complete.

As one example, explained is a configuration wherein multiple consumption timings are set in the period from the start to the completion of the training for a target team and/or a target individual player, and action points (an example of the first parameter) are consumed at each consumption timing. In this configuration, on the condition that the action points are consumed at each of the consumption timings, the game for training the training target is carried out each time.

Namely, at the timing the training of one character or one team is started, rather than consuming many points, etc., at once, action points are consumed at each of the multiple consumption timings after the start of training, whereby it is possible to proceed the training game each time. In this way, the total costs required from the start to the completion of training can be divided into small portions to be consumed at respective consumption timings. It is therefore possible to reduce the action points required at one time. As a result, the burden on the user to carry out the training game can be reduced.

In the following, one example of the game of the present embodiment will be explained in details.

(2-1. Initial Settings before Starting Game)

Before starting the game of the present embodiment, the user can set information on area, high school name, team design, school song, cheering song, rival school, etc. These are information set only the first time the user starts the game. However, it may be arranged that the user can change the setting as necessary even after the game starts. The set respective information are stored in association with the user identification information.

The area information is the in-game area information where the user's high school is located. For example, users can choose any one of the 47 prefectures. Depending on the prefecture selected, the difficulty (for example, whether a strong school exists on the opposing team, etc.) of the matches of prefectural tournaments held as appropriate within the game or the number of matches are different. Selecting an area with a higher difficulty or more matches, offers the benefit of expecting greater team growth, but it also carries the risk of early elimination from the competition. Therefore, users consider these trade-offs when making their selection.

Further, according to the area selected by the user, players corresponding to professional baseball players who exist or existed in the real world (hereinafter referred to as “reincarnated players”) are more likely to join the user's team. For example, if the area selected by the user is the area of the reincarnated player's origin, the possibility of the reincarnated player joining the user's team is higher than that of the case where the user selects other areas.

Further, it may be configured such that the user can select the age year to start the game (for example, 1990, etc.), so that reincarnated players corresponding to professional baseball players who entered high schools located in the user's selected area in that age group are more likely to join the user's team.

The rival school mentioned above is a high school that appears as an opponent team in a tournament that takes place in the game at an appropriate timing, and for example, the user can select the rival school from the high schools (teams) of the user's friend. Here, user's friends are other users associated with the user, who can be any of other users the user follows, other users followed by the user, or other users the user follows and followed by the user.

### (2-2. Players Included in Team)

A plurality of players who join the user's team as the training targets include scholarship students (examples of the first affiliated object) and general enrollment students (examples of the second affiliated object).

### (Scholarship Student)

The “scholarship student” is a player character that the user can arbitrarily add to the team from the characters called scholarship students (an example of objects owned by the user, in association with user identification information). In this embodiment, the user can add up to three scholarship students in the team at every entrance ceremony event (April 8 every year). Therefore, maximum of nine scholarship students can join the team overall.

Here, each scholarship student has an advantageous effect for training (for example, the effect that causes special ability icons or equipment icons to appear, to be described later), that general enrollment students do not have.

Further, scholarship students may have higher initial abilities than the general enrollment students.

The user can obtain characters of scholarship students, for example, in lottery mode. In this lottery mode, for example, a lottery (so-called gacha) is performed to grant a character to the user from among all the characters of the scholarship students in the game. To run the lottery mode, for example, the user is required to use a predetermined amount of in-game points, a paid item, etc. may be required.

The user can also obtain the scholarship students as a reward by fulfilling a predetermined condition (for example, winning a match) within the game. Further, the user may obtain scholarship students from other users or by exchanging with other users.

There are parameters set for scholarship students. For the fielder's abilities, such parameters as trajectory, meet, power, running speed, defensive ability, arm strength, and catching ability are set. For the pitcher's abilities, such parameters as ball speed, control, stamina, pitch types, total change in curveball are set. Additionally, a parameter called special ability may be set to the scholarship students.

Further, a parameter of reality is also set for scholarship students. The rarity parameter indicates difficulty in obtaining. In this game, there are four types of rarity: R, PR, SR, and PSR, and scholarship students with the same name may have different types of rarities. For the rarity types, in the order of R, PR, SR, and PSR, the reality becomes higher, and even among the scholarship students with the same name, higher initial abilities are set for those with higher rarity. Here, “initial abilities” refer to the parameters of each player's abilities that are initially set. As the training game progresses, the parameters of the training target change from the initial abilities, to be described later.

### (General Enrollment Students)

The above-mentioned “general enrollment student” is a player that is not owned by the user, and is a mob character generated by the game system 1 (CPU31, etc.). In the present embodiment, up to seven general enrollment students are admitted to join the team at each entrance ceremony event. Therefore, maximum of twenty-one general enrollment students can join the team overall.

The general enrollment students have the effect (function) of enhancing the effect produced by the scholarship student to be described later.

Also, for the general enrollment students, parameters are set. For the fielder's abilities, such parameters as trajectory, meet, power, running speed, defensive ability, arm strength, and catching ability are set, and for the pitcher's abilities, such parameters as ball speed, control, stamina, pitch types, total change in curveball are set. Additionally, a parameter called special ability may be set also to the general enrollment students.

The initial abilities of the general enrollment students are determined based on probability at the entrance ceremony event. Each user belongs to any one of several classes, and the higher the user's class, the higher the probability that the higher initial ability is set to the general enrollment student.

To explain the above class, each user starts with the lowest “rookie” class and is promoted to a higher class when a predetermined class up condition is met in the game. Each class has five levels of reputation, which increase in the order of weak, average, mid-level, strong, and prestigious, and its reputation rises each time the user meets a predetermined reputation increase condition in the game. Here, the reputation rises, for example, by winning a in-game match or performing a predetermined event. By meeting the predetermined class up condition with the highest reputation “prestigious” of the class, the user can be promoted to a higher class.

For example, there is a stage assigned to the class, and multiple tasks are set according to the growth of the training target within that stage. It may be configured that the user is rewarded each time he/she completes the task, and each time the user meets the reputation up condition, the reputation in the class rises. It may be further configured that when all the tasks in the stage assigned to the current class are completed, the class up condition is met, and the user is promoted to a higher class, whereby a higher stage is unlocked.

For each player (including a scholarship student and a general enrollment student), a defensive aptitude parameter is set for each defensive position. For example, there are 5 levels of defensive aptitude (for example, main, sub+, sub, sub−, no aptitude) for each defensive position. The player's defensive aptitude is subject to change by performing a defensive practice.

Similarly, for each player (including a scholarship student and a general enrollment student), a pitching aptitude parameter is set. For example, the pitching aptitudes are set respectively for a starting pitcher, a relief pitcher, and a closing pitcher. The pitching aptitude of the player is also subjected to change by performing a pitching practice.

Further, each player (including a scholarship student and a general enrollment student) has individual parameters for academic ability (deviation value). The initial value of academic ability is determined, for example, based on probability. In the case of a scholarship student, it may be configured such that the higher the rarity is, the higher is the initial value of academic ability. Each player's academic ability increases or decreases by an in-game event or using an academic ability variation item (for example, reference book item). The academic ability affects the probability of a predetermined event occurring, the number of times of use of a predetermined item, and the player's career path after graduation, etc.

Further, each player (including a scholarship student and a general enrollment student) has individual personality parameter as set. There are multiple personalities, such as “very normal”, “genius skin”, and “cool”, and each player has one of these personalities. The personality of the scholarship student is predetermined according to the scholarship student, but it may be configured that the personality is set based on lottery. The personality of general enrollment student is determined by lottery at the time of generation. Depending on this personality, the experience points obtained through individual practice, the type of an event that occurs, and the tactics during the game are affected.

Further, parameters such as reliability, scouting evaluation, condition, and physical strength are also set for each player (including a scholarship student and a general enrollment student). The degree of reliability or the scouting evaluation increases or decreases depending on performance in the game (batting average, etc.), the predetermined event, etc. The reliability affects tactics during the game and the outcome of ongoing events. The scouting evaluation will affect the registration of individual players, which will be described later. The condition is determined based on lottery from five stages, for example; however, the condition varies depending on the outcome of the event and the use of a predetermined item. This condition affects tactics and how physical strength decreases during the game. The physical strength increases or decreases with a predetermined event, an item, practice, etc. The amount of experience points gained from practice varies depending on this stamina such that the higher the level of stamina is, the more experience points the user can obtain.

Further, each player (including a scholarship student and a general enrollment student) has a parameter of school year (the 1^{st} year student, the 2^{nd} year student, and the 3^{rd} year student). The player's school year is basically the 1^{st} year at the time of high school admission, and one school year is added every year on April the 1st.

At the start of the game, some of the players on the user's team may include the 2^{nd} year or the 3^{rd} year student player.

### (2-3. Setting of Training Target (Players))

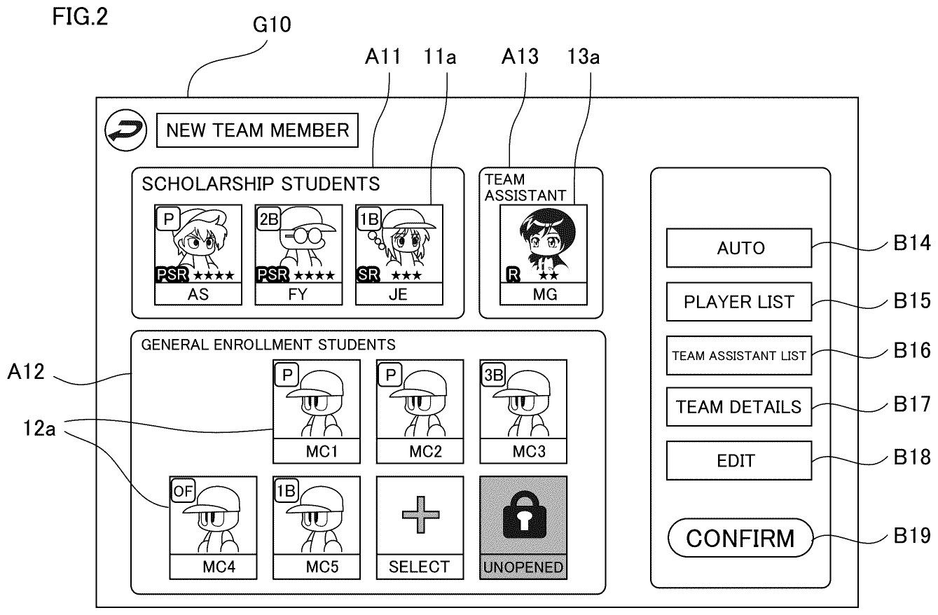

Every year, an entrance ceremony event occurs at a predetermined time (for example, April 8th), and a user is allowed to make the new student player (including a scholarship student and a general enrollment student) to join the team. FIG. 2 illustrates an example of the new member screen G10 for the user to set up new student players to join the team.

### (Admission of Scholarship Students)

The area A11 of the new member screen G10 is an area for setting a predetermined number of scholarship students to be joined to the team as new student players. In the example in FIG. 2, provided are three setting frames 11a for setting up to three scholarship students. Here, it may be configured that the configurable number (the upper limit) of the scholarship students varies depending on the user's class, etc.

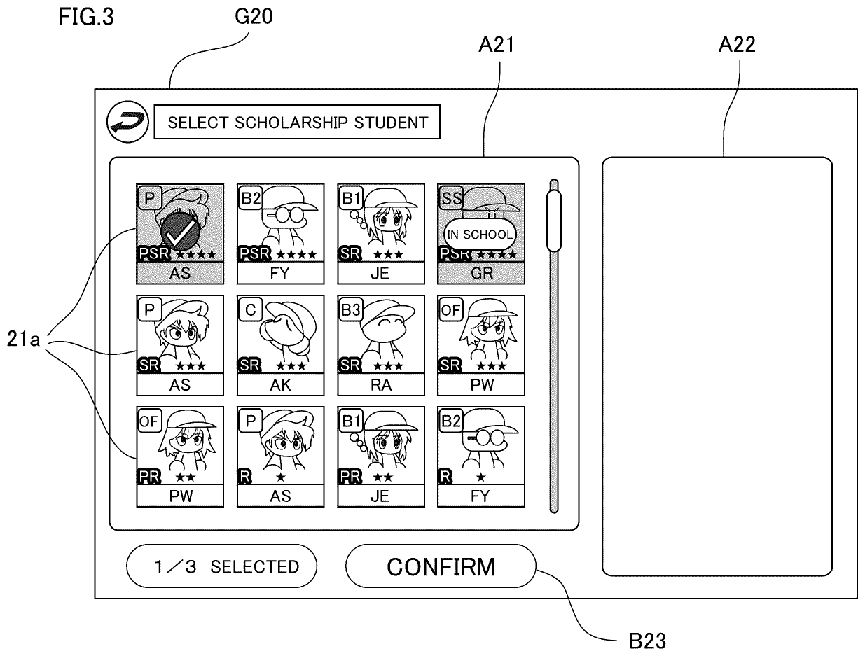

By performing a user's operation of selecting the setting frame 11a (a touch operation to the touch panel, an operation with the controller, etc.), the screen transitions to the scholarship student selection screen G20 as illustrated in FIG. 3. This scholarship student selection screen G20 is a screen for a user to select or change a scholarship student to join as a new student player. In the area A21 of the scholarship student selection screen G20, displayed is a list of prospective members of the plurality of scholarship students 21a owned by the user. The user can set the scholarship students to be joined to the team by selecting at least one scholarship student (for example, by touching the target scholarship student, etc.) and operating the select button B23.

The scholarship student selected by the user is marked as selected. Further, the scholarship students in their 2^{nd} year or the 3^{rd} year who have already joined the team are labeled as “enrolled” and cannot be selected.

An area A22 of the scholarship student selection screen G20 is an area that displays the individual abilities of the selected scholarship students and the information of the team including the selected scholarship students. The user can select scholarship students while checking various information displayed in the area A22.

Further, it may be configured that not only scholarship students owned by the user but also a predetermined number (only one) of scholarship students owned by other users (for example, the user's friends) are admitted to join the team. For example, based on a given probability, a scholarship student of a user's friend (or may be other users who are not friends) may be selected as a prospective member. The scholarship student owned by the friend selected as the prospective member is listed on the scholarship student selection screen G20 along with the scholarship students owned by the user, so that the user can select from the list. It may be also configured that at each entrance ceremony event, a certain number (one, for example) of scholarship students owned by the friend is admitted to joint the team as new members.

When the user selects the scholarship students and operates the select button B23, the screen returns to the new member screen G10 of FIG. 2, and the selected scholarship students are set to the setting frame 11a.

When the scholarship students are set in the setting frame 11a, the information of the scholarship students is displayed. For example, displayed are the image (thumbnail), the position, the rarity, the name, etc. of each of the scholarship students.

Note that, by default, the CPU31 may automatically select a configurable number of scholarship students from among the scholarship students (characters) owned by the user based on the predetermined selection criteria, and set them in each of the setting frames 11a of the area A11. For example, in order of priority, the scholarship students are automatically selected based on the rarity level, the player ability, the player ID, etc.

### (Admission of General Enrollment Student)

The area A12 of the new member screen G10 is an area for setting a predetermined number of general enrollment students to be joined to the team as the new enrollment students. In the example of FIG. 2, there are seven setting frames 12a that can set up to seven general enrollment students. Here, it may be configured that the configurable number (the upper limit) of the general enrollment students varies depending on the user's class, etc. FIG. 2 illustrates an example in which the configurable number of general enrollment students is six and one of the seven setting frames is not opened.

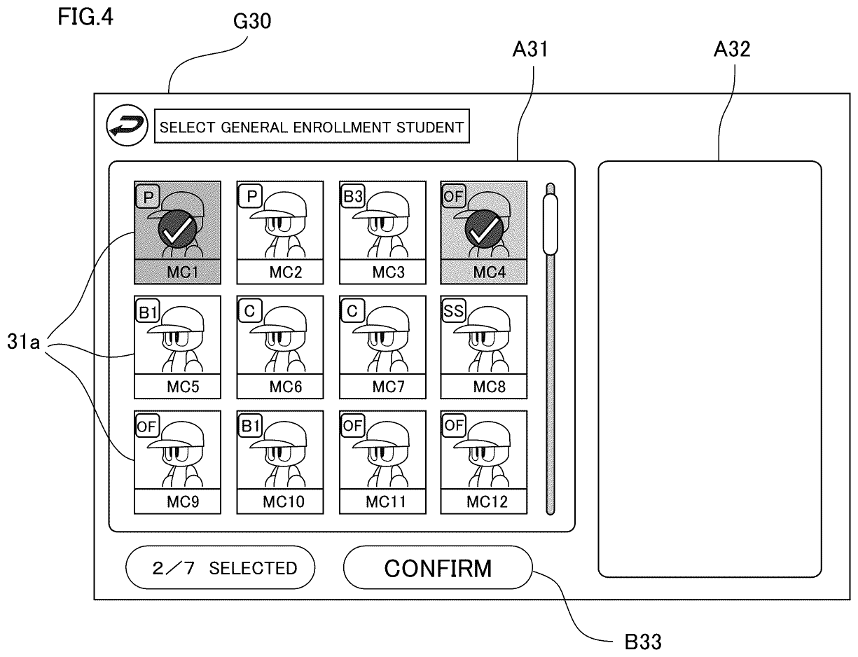

By performing the user's operation of selecting the setting frame 12a, the screen transits to a general enrollment student selection screen G30 as illustrated in FIG. 4. This general enrollment student selection screen G30 is a screen for a user to select or change general enrollment students who join the team as new members. In an area A31 of the general enrollment student selection screen G30, displayed is a list of a plurality of prospective general enrollment students 31a who wish to join the team, generated by the game system 1. For example, it may be configured to display a list of a predetermined number of general enrollment students selected based on lottery from among all the general enrollment students managed by the game system 1 in the game. The user can set the general enrollment student to be joined to the team by selecting at least one of the general enrollment students and operating a select button B33.

The area A32 of the general enrollment student selection screen G30 is an area that displays the information of the individual abilities of the selected general enrollment students and the information of the team including the selected general enrollment students. With reference to the various information displayed in the area A32, the users can select the general enrollment students.

Further, in the general enrollment student scout event to be described later, players scouted beforehand by the user may be included in the general enrollment students who wish to join the team based on probability.

When the user selects the general enrollment students and operates the select button B33, the screen returns to the new member screen G10 of FIG. 2, and the selected general member is set to the setting frame 12a.

When the general enrollment students are set in the setting frame 12a, the information of the general enrollment student is displayed. For example, images (thumbnails), positions, names, etc., of the general enrollment students are displayed.

Moreover, by default, the CPU31 may automatically select a predetermined number (configurable number) of general enrollment students from among the plurality of general enrollment students based on the predetermined selection criteria to be set in each setting frame 12a of the area A12. For example, the general enrollment students may be automatically selected based on priority, such as pitchers, positions with zero aptitude, high player ability values, and player ID order, etc.

As mentioned above, the scholarship students have the favorable effect on training, while the general enrollment students enhance the effect produced by the scholarship students. As a specific example, scholarship students are associated with an effect that causes special ability icons or equipment icons to appear (an effect the general enrollment students do not have), and the general enrollment students are associated with the effects of enhancing the effect of the special ability icons or the equipment icons appeared (effects the scholarship students do not have).

Here, there are a plurality of types of special ability icons (for example, slugger, artist, infield hit, etc.). Similarly, there are a plurality of types of equipment icons (for example, for hitting, weight training, base running, etc.).

The type of special ability icon or equipment icon that appears varies depending on the scholarship student. Further, the type of special ability icons or equipment icons whose effects are enhanced differs depending on the general enrollment student. If the general enrollment student is associated with an effect that improves the effect of the equipment icon of the hitting type, the effect of the general enrollment student is meaningless unless the equipment icons of the hitting type appear. Therefore, in this case, to leverage the effect of the general enrollment student, it is important that both the scholarship student, who has an effect associated with making batting equipment icons appear, and the above general enrollment student belong to the same team.

Therefore, when the user is recruiting new students into the team, it is necessary to consider the balance between the effect of scholarship student and the effect of general enrollment students (which enhances the effect of scholarship student), and decide which scholarship student or general enrollment student to recruit, considering the effective combination of the two.

In this case, it is also important for the user to recruit new members (including scholarship students and general enrollment students) with effects that complement the effects already possessed by the 2^{nd} year and the 3^{rd} year student players in the team. For example, in the case where the 2^{nd} year and the 3^{rd} year scholarship student players, who have effects associated with the effect that makes batting equipment icons appear, already exist in the team, and the user desires to improve the hitting power of the team, the user considers recruiting one or more general enrollment students who have an effect associated with enhancing the effect of hitting-type equipment icons.

As mentioned above, it is necessary for the user to select the scholarship students or the general enrollment students to join the team based on the balancing the effects of the scholarship students with the effects of the general enrollment students (the effect of enhancing the effect of the scholarship student members), thereby realizing a highly entertaining game.

### (Team Assistant Enrollment)

The area A13 of the new member screen G10 is for setting a predetermined number of team assistants who join the team as new members. In the example of FIG. 2, a setting frame 13a is provided that allows for the assignment of single team assistant. The configurable number (upper limit) of the team assistants may vary according to the user's class, etc.

There are two types of team assistants: “premium team assistants” and “general team assistants.

The “premium team assistant” is a character owned by the user. The user can obtain the character of the “premium team assistant”, for example, in lottery mode, or as a reward by fulfilling a predetermined condition (for example, winning a match) within the game. The premium team assistants respectively have rarity parameters as set, and even the premium team assistants with the same name may have parameters of different rarities. The higher is the rarity of the premium team assistant, the larger is the number of events that can occur, and the greater is the effect of training on the training target.

The “general team assistant” is a character that is not owned by the user, and is a mob character generated by the game system (CPU 31, etc.). During the entrance ceremony event, the game system generates at least one general team assistant.

By having the team assistant join the team, the team assistant affects the training of the training targets. For example, an event occurs depending on the team assistant, and the team assistant may participate in training sessions linked to the progress icon described later. This participation provides effects such as reducing the stamina consumption or increasing the trust level of the participating players. Here, premium team assistants have a higher training effect on the training targets than general team assistants.

An upper limit (for example, one) is set on the number of premium team assistants who can join the team. This upper limit may vary depending on the user's class, or other factors.

When the user performs an operation of selecting the setting frame 13a, the screen transitions to the team assistant selection screen (not shown), and the user can select or change the team assistant to join the team as the new member. When the team assistant is set in the setting frame 13a, the team assistant's information (thumbnail, rarity, name, etc.) is displayed.

By default, the CPU31 may automatically select a predetermined number (configurable number) of team assistants from among the selectable team assistants based on the predetermined selection criteria to be set in the setting frame 13a of the area A13.

On the new member screen G10, provided are an auto button B14, a player list button B15, a team assistant list button B16, a team details button B17, an edit button B18, and a select button B19.

When the user operates the auto button B14, the CPU31 automatically selects and sets a configurable number of scholarship students, general new students, and team assistants based on the predetermined selection criteria.

By operating the player list button B15, the user can confirm the list of the players belonging to the team. By operating the team assistant list button B16, the user can confirm the list of team assistants belonging to the team. By operating the team details button B17, the user can check the detailed data of the team. By operating the edit button B18, the user can edit the appearance (hair, eyebrows, eyes, beard, body shape, etc.) and the color of the gloves of the specified general enrollment students. Then, by operating the select button B19, the admission of the set scholarship student, general enrollment student, or the team assistant is confirmed.

### (2-4. Execution of Training)

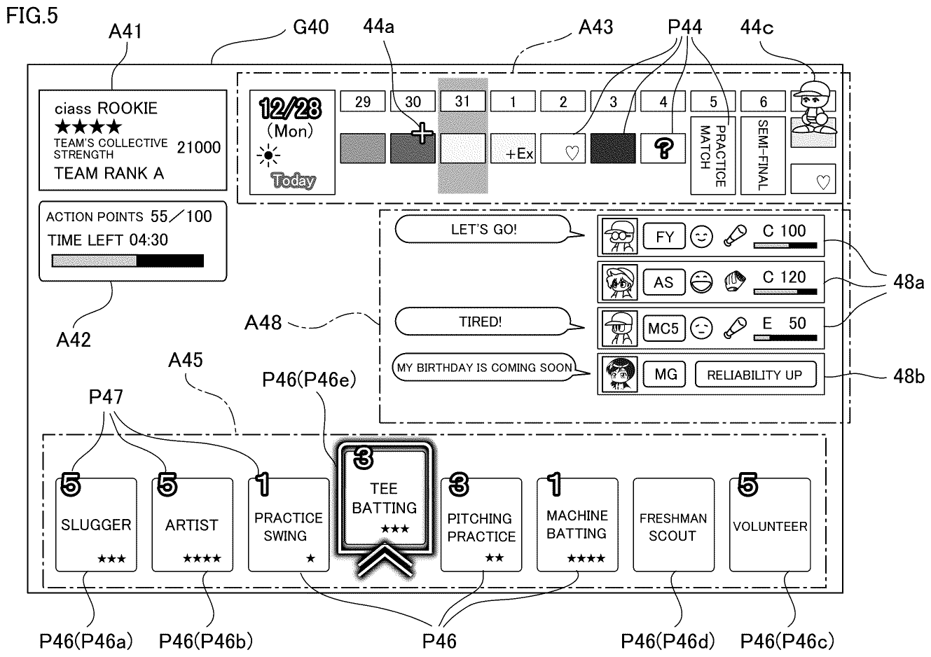

FIG. 5 illustrates an example of a main progress screen G40 for executing the training of a training target.

The display area A41 displays the user's information such as the user's class, reputation (number of stars), the overall team strength, the team rank, etc. The overall team strength is the overall ability of the team calculated from the ability of the starting members and the 18 players on the bench. The team ranks are divided into multiple levels (for example, G to A, and S) according to the value of the overall team strength.

A display area A42 displays the information on the points, called action points for executing the training game (as an example of the first parameter). There is an upper limit for the action points. In the display area A42, the upper limit of the action points, the current value, and the current remaining amount are displayed on the gauge. The action points will be described in details later.

### (Map)

The progress screen G40 displays a map A43 that indicates the progress of the game. In the present embodiment, shown is an example where the schedule progresses at least on day-by-day basis in-game time. The map A43 displays at least one panel P44 (square) every in-game day. The number of panels (days) displayed in the map A43 can be set arbitrarily. For example, the panels for 10 days may be always displayed, or the number of panels displayed may vary.

For example, as the game progresses, the panel P44 in the map A43 is updated so that the left end of the map A43 is the current panel P44 (on the same day). The timing of updating the panel P44 is not limited to the above, and the panel P44 in the map A43 may be updated as the game progresses, for example, not less than a predetermined progress (five days or more).

There are several types of panels P44 displayed in the map A43. Depending on the type, the color, shape, text, and illustrations displayed on the panel P44 differ, allowing the user to recognize the type of panel. Furthermore, the effect generated varies depending on the type of the panel P44.

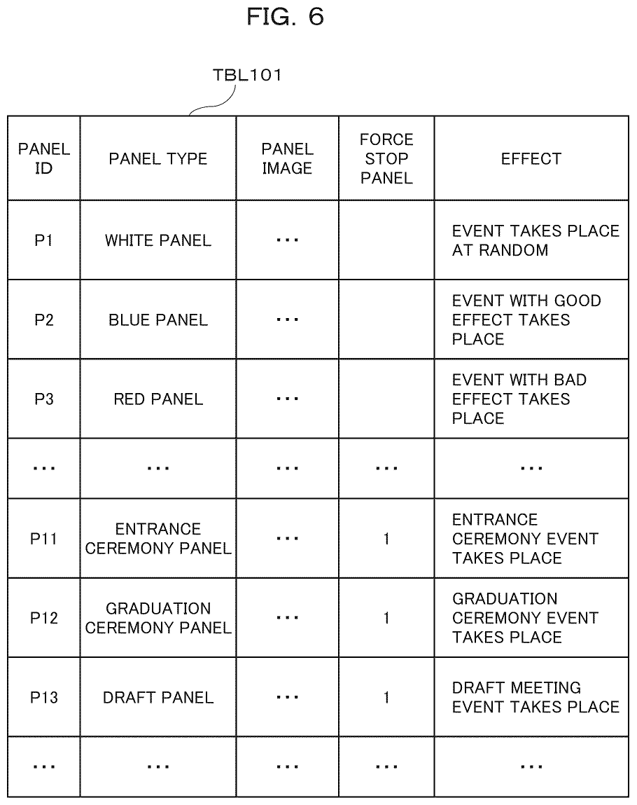

FIG. 6 illustrates an example of the panel information table TBL101. The panel information table TBL101 includes the fields: a “panel ID”, a “panel type”, a “panel image”, a “force stop panel”, and an “effect”. The “panel ID” is the information that uniquely identifies each panel P44. The “panel type” is the name that distinguishes each panel P44. The “panel image” is the image information of the panel. The “force stop panel” is the information indicating a panel of definite stop (for example, “1” indicates a force stop panel). The “effect” is the information about the effect that occurs when it stops at the pane P44.

for example, the panel p44 includes a “white panel” where an event occurs randomly, a “blue panel” where an event causing a good effect (advantageous effect) occurs, a “red panel” where an event causing a bad effect (disadvantageous effect) occurs, a “yellow panel” where the experience points for the selected exercise with the progress icon to be described later increases by a given factor, a “green panel” where the physical strength is recovered, a “schedule panel” where a progress route is selected from among the three progress routes, a “team assistant panel” where an event occurs according to the premium team assistant in the team, etc.

Further, in the “character panel”, on which characters (graduates) of the city people, to be described later or scout characters 44c are displayed, an event corresponding to the character 44c displayed on the panel p44 occurs. For example, in the case where the character 44c displayed on panel p44 is the “scout”, the scout evaluation of the team's players improves. In the case where the character 44c displayed on panel p44 is a “craftsman”, a baseball tool item is obtained. In the case where the character 44c displayed on panel p44 is a “butcher”, for example, an event occurs at which power-type experience points are increased by a predetermined factor, etc. For example, multiple types of scouts may exist, and if the types are different, their effects (such as the increase rate of scout evaluation) may also differ.

Further, the force stop panel includes, for example, an “entrance ceremony panel” where an entrance ceremony event occurs, a “graduation ceremony panel” where a graduation ceremony event occurs, a “draft panel” where a draft meeting event occurs, a “farewell party panel” where a farewell party event occurs, an “official game panel” where an official match is executed, and a “practice game panel” where a practice match is executed, and the like.

There is also a panel P44 in which the route changes depending on the outcome of an event. For example, for the “official match panel” and the “practice match panel”, a route for winning and a route for losing exist depending on the outcome of the match (win or lose).

Further, the panel P44 includes such panel that at least one target player is randomly selected or based on a predetermined selection criterion, and an event occurs according to the parameters of the target player. Examples of the panel P44 include a “special training panel” where a target player can obtain a special ability with a predetermined probability, a “test panel” where an event occurs according to the target player's academic ability, a “cultural festival panel” where an event occurs according to the personality of the target player, and a “sports festival panel” where an event occurs according to the ability of the target player, and the like. For example, in the case of the “special training panel”, three players are randomly selected from within the team, and the user can select the player he/she wishes to train to acquire a special ability.

Other than the above, examples of the panel P44 also include a “training camp panel” where at least one target player can acquire special abilities based on probability, an “expedition panel” where a joint practice and a practice match are performed with other user's team at an expedition site selected by the user, and a “?panel” where the content of the panel is undecided and will be determined once it stops.

Two or more events may be associated with one panel P44.

For example, in the case where with the predetermined panel P44 (for example, the “scholarship student panel”, the “premium team assistant panel”, the “mandatory stop panel”, etc.), additional events (2 or more events) are associated, an addition event label 44a is displayed. In the example of FIG. 5, the addition event label 44a with a “+” mark is displayed. With the panel P44 where this addition event label 44a is displayed, the user can recognize that a plurality of events will be held.

### (Progress Icon)

The progress screen G40 has a progress icon display area A45. In this progress icon display area A45, a predetermined number of progress icons P46 selectable by the user in each turn are displayed. The number of progress icons P46 to be displayed can be set arbitrarily. The number of progress icons P46 can be fixed or variable. In this embodiment, a minimum of 4 to a maximum of 8 progress icons P46 are displayed, and the higher the user's class, the greater the number of progress icons P46 displayed. Until the user's class changes, the number of progress icons P46 displayed each turn remains constant.

As a variation, the number of progress icons P46 displayed may be changed randomly, at predetermined intervals (for example, every turn, every 5 turns, etc.) or irregularly or at random.

The progress icon P46 is essentially a command for giving instructions such as practice to a team (a plurality of players in the team). In other words, it is a command given to the whole team, not to individual players. The progress icons P46 may include a progress icon (for example, a new student scout, etc., to be described later) other than the command to give team-based instructions.

The plurality of progress icons P46 displayed in the progress icon display area A45 are determined by lottery based on a predetermined probability of appearance. The user selects one of the plurality of progress icons P46 displayed for each turn and executes the command (or event) for practice, etc., associated with the selected progress icon P46 to progress the game. For example, by tapping one of the plurality of displayed progress icons P46 with a finger, any desired progress icon P46 is selected (placed in a temporary selection state”, and by tapping the selected progress icon P46 again, the selection of the progress icon P46 can be confirmed. Then, the command associated with the progress icon P46 is executed. FIG. 5 illustrates an example where the “tee batting” icon P46e is in the temporary selection state.

A number indicating the number of days the practice or the like is performed is displayed as progress day information P47 (progress amount information) for each progress icon P46. In this embodiment, any number of 1 to 5 is associated with each progress icon P46 currently displayed as the progress day information P47.

For the number of days displayed on the progress icon P46 selected and executed by the user, the panel P44 in the map A43 progresses, and an event occurs according to the panel P44 that is stopped on. In other words, in the game of this embodiment, when the user selects and executes the progress icon P46, the command (or event) associated with the progress icon P46 is executed, and the event(s) associated with panel P44, stopped after progressing by the number of days displayed on the progress icon P46, is also executed.

In this way, the in-game time progresses for the number of days on the progress icon P46 selected and executed by the user.

Basically, an event associated with the panel P44 landed on occurs, while an event associated with the panel P44 that passed through without stopping does not occur. However, if the panels P44 that passed through include the force stop panel, it is once stopped at the force stop panel, and the event associated with the force stop panel is guaranteed to be executed before proceeding to panel P44 where you should stop. In this case, after the event of the force stop panel is executed, it proceeds to panel P44 where it should stop, and the event associated with that panel P44 also occurs.

As a variation, it may be configured such that if the force stop panel exists on the user's way to progress the number of days displayed on the progress icon P46 that the user has progressed, the user lands on the force stop panel, and the game progression for that turn stops there.

Like the “new student scout” icon P46d, to be described later, such progress icon P46, which does not display the progress days information P47 may be included. In the case where the progress icon P46 which does not display the progress days information P47 is selected and executed, the progress icon P46 is executed as the event on the day without the progress schedule.

There are multiple types of progress icons P46, and the effects that occur vary depending on the type.

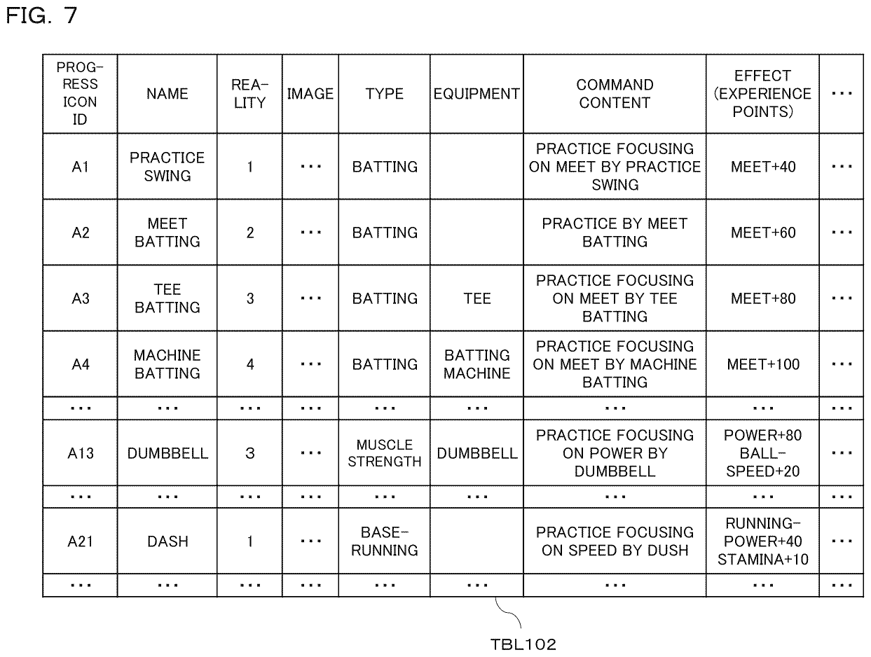

FIG. 7 illustrates an example of the progress icon information table TBL102. The progress icon information table TBL102 includes the fields of a “progress icon ID”, a “name”, a “rarity”, an “image”, a “type”, an “equipment”, a “command content”, and an “effect”.

The “progress icon ID” is the information that uniquely identifies each progress icon P46. The “name” is a name that distinguishes each progress icon P46. The “rarity” indicates the rarity (low appearance rate) of the progress icon P46. In the present embodiment, a four-stage rarity level is set, ranging from 1 to 4, and the higher the rarity of the progression icon P46, the greater the training effect. FIG. 5 illustrates an example where the rarity of each progress icon P46 is displayed on the progress screen G40 by the number of stars.

The “progress icon image” is the image information of the progress icon P46.

The “type” refers to information that classifies the content of practices and training associated with the progress icon P46 into multiple types such as “hitting type”, “strength training type”, “baserunning type”, “arm strength type”, “fielding type”, “mental type”, “ball speed type”, “control type”, “stamina type”, “breaking ball type”, “special ability type”, and “others”.

The “equipment” is information indicating the type of the equipment in the case where the practice associated with the progress icon P46 is the practice using equipment. Equipment includes items such as a tee, a batting machine (or pitching machine), dumbbells, a stopwatch, etc.

The “command content” is the information indicating the content of the command (or event), such as practice, associated with the progress icon P46.

The “effect” is the information that indicates the effect which occurs when a command (or event) associated with the progress icon P46 is executed.

This effect is applied to each player on the team and includes information on the type of ability that increases experience points and the reference amount of the experience points to be improved.

The “slugger” icon of the progress icon P46a and the “artist” icon of the progress icon P46b of FIG. 5 are examples of the progress icon P46 of the special ability. The progress icon P46 of the special ability is called the “special ability icon”. By selecting the special ability icon and executing the command, the experience points are improved for a player of the team to acquire the corresponding special ability. Here, the experience points may be increased only for the players participating in practice, or for all the players in the team. When the experience points reach the standard, the player(s) can obtain the special ability.

The special ability icon may appear as the progress icon P46 by having a specific scholarship student, with the effect of increasing the appearance rate of the special ability icon, join the team. In other words, if the above-mentioned specific scholarship student is not included in the team, the corresponding special ability icon does not appear. There are several types of special ability icons, such as the “slugger” icon, the “artist” icon, the “infield hit” icon, etc. For example, if the scholarship student is in the team who is associated with the “artist” icon increase effect, the “artist” icon can appear, while if such scholarship student is not in the team, the “artist” icon does not appear.

Furthermore, the progress icon P46 associated with the equipment is referred to as an “equipment icon”. The equipment icon may appear as progress icon P46 by having a specific scholarship student, with the effect of increasing the appearance rate of the equipment icon, join the team. In other words, if the above-mentioned specific scholarship student is not included in the team, the corresponding equipment icon does not appear. There are several types of equipment icons, for example, those of hitting type (batting tees, hitting machines), those of strength type (dumbbells, bench presses), and those of baserunning type (stopwatches, mini-hurdles), etc.

Each special scholarship student is associated with an effect that increases the appearance rate of at least one of multiple types of special ability icons or equipment icons. There may be scholarship students who are not associated with an appearance rate increase effect.

Other than the “special ability icon” or the “equipment icon”, such progress icon P46 may be provided, which is associated with players (including scholarship students or general enrollment students) and which can appear by enrolling the players in the team.

As a variation, even if the above-mentioned specific scholarship student is not included in the team, there is a certain probability that the special ability icon or the equipment icon may appear with a predetermined probability.

A “volunteer” icon P46c and a “new student scout” icon P46d of FIG. 5 are examples of other types of the progress icons P46. When selecting the ‘volunteer’ icon P46c, an event occurs where the trust of all participating players is increased by a certain amount. When selecting the “new student scout” icon P46d, an event occurs where new members can be scouted for the next year. The progress icons (P46) for non-training commands such as a “review training menu” icon, a “career path consultation” icon, and a “team dinner” icon are also included.” With the “review training menu” icon, all currently displayed progress icons can be replaced. With the “career counseling” icon, an event occurs where carrier advices are available for the players in the team. With the “team dinner” icon, an event occurs where a team dinner party is held. Other than the above, various types of the progress icons P46 may be provided.

### (Practice Participating Players)

A practice participation player display area A48 of the progress screen G40 displays practice participating players 48a or the team assistant 48b associated with to the currently displayed progress icon P46.

The players displayed in the practice participation player display area A48 are called “practice participating players”. The maximum number (upper limit) of participants for the practice participating players 48a or the team assistants 48b displayed in the practice participation player display area A48 vary depending on the user's class. In the present embodiment, the maximum number of participants varies between three and five, and the higher the user's class, the larger the maximum number of participants.

However, not limited to the above, the maximum number of participants can be set arbitrarily. For example, the maximum number of participants may be fixed.

The information of the practice participating players 48a displayed in the practice participation player display area A48 includes information such as player's images (thumbnails), nameplates (names), conditions (condition marks), ability scores, ability gauges, dialogue, etc. Regarding player's dialogue, the dialogue corresponding to the player's current state will be displayed, and the same can be said for the team assistant's dialogue.

In the case of the team assistants 48b displayed in the practice participation player display area A48, the information such as images (thumbnails), team assistant's effect, dialogue, and the like is included. The team assistant's effect includes “reliability level up” and “stamina consumption reduction”, and the like, and the team assistant's effects of the team assistants participating in the practice are displayed.

The practice participating players 48a can obtain more experience points than other players in the team. Basically, the players in the team who are not displayed in the practice participation player display area A48 also can obtain experience points according to the practice of the progress icon P46.

Here, the progress icon P46, which has the effect of increasing the experience points only for the practice participating players 48a may be included.

The practice participating players 48a or the team assistants 48b are selected every turn by lottery from among all the players and the team assistants included in the team.

If the players (including a scholarship student and a general enrollment student) who have the effect of increasing the rate of practice for a specific practice are included in the team, the probability of the player being selected as the practice participating player 48a is increased. Namely, in the case where the progress icon P46 corresponding to the above specific practice is included in the multiple progress icons P46 displayed in the current turn, the probability that the player with the effect of increasing the practice rate for the specific practice is selected as the practice participating players 48a becomes higher than other players.

For example, as described below, a user can instruct each player belonging to the team to practice individually, apart from the practice instructions for each team. With this individual practice instruction, the effect of increasing the practice rate for a specific practice can be set for each player. For example, for the player instructed to perform an individual practice of improving the running power, the practice rate increasing effect is set for the practice on the “running power”. For the player instructed to practice individually to increase the ball speed, the practice rate increase effect for the “ball speed” practice is set.

In the case where the practice participating players 48a include at least one scholarship student who satisfies the predetermined condition, and the scholarship student participates in the designated practice (when the command for progress icon P46 associated with that practice is executed), a coaching tag event occurs. When this coaching tag event occurs, the scholarship student who activates the coaching tag event will have the effect of increasing the experience points more than usual. Here, the larger is the number of the scholarship students who activate the coaching tag event, the larger is the effect. The above predetermined condition can be set arbitrary, for example, the reliability of the scholarship student who is the practice participating player 48a is a predetermined value or above, etc.

In the case where there is the progress icon P46 that can trigger the coaching tag event among the plurality of progress icons P46 displayed in the progress icon display area A45, that progress icon P46 is highlighted (displayed in different manner from other progress icons P46). In FIG. 5, an example is shown where the frame of the “tee batting” icon P46e is highlighted with light.

As a variation, when the coaching tag event occurs, the experience points gained by all practice participating players 48a or all players in the team (including scholarship students or general enrollment students) may increase more than usual.

Further, the execution results such as the practice of the progress icon P46, the instruction tag event, or the event of the stopped panel P44 are displayed on the result display screen, which is superimposed on the progress screen G40, for example.

Further, on the progress screen G40, buttons such as a fast-forward button, a log button, a menu button, and a hint button may be displayed. The fast-forward button is for adjusting the display speed of text displayed on the result display screen, etc. The log button is for checking the log of the results of practice, etc. The menu button is for displaying various menus. Examples of the menus include a menu for a user to set team orders and team policies, etc. The team policy includes an emphasis on balance, an emphasis on hitting power, an emphasis on mobility, and an emphasis on pitching and defense, etc. The hint button is for displaying hints that are useful for training the training target when pressed.

### (Individual Practice Instruction for Each Player in Team)

In addition to the team-based practice instructions given via the above progress icon P46, the user can individually instruct each player belonging to the team to practice. Individual practice for individual players is called “individual practice”.

Instructions for individual practice by the user may be given at prescribed timings set beforehand (for example, every week, every month, or every two months in-game time, or every 12 hours, every day, or every week in the real world time). In this embodiment, individual practice instructions can be given at the beginning of each month of in-game time (i.e., when extending into the next month).

As a variation, for example, an individual practice instruction may be given at irregular timings determined based on probability. As a specific example, a lottery for individual practice is performed based on a predetermined probability in each turn, and when selected by lottery, an individual practice can be instructed.

In the present embodiment, when the game progresses and extends into the next month within the schedule on map A43 based on the progress days information P47 displayed on the progress icon P46 selected by the user, after all events end, a transition is made to individual practice instruction.

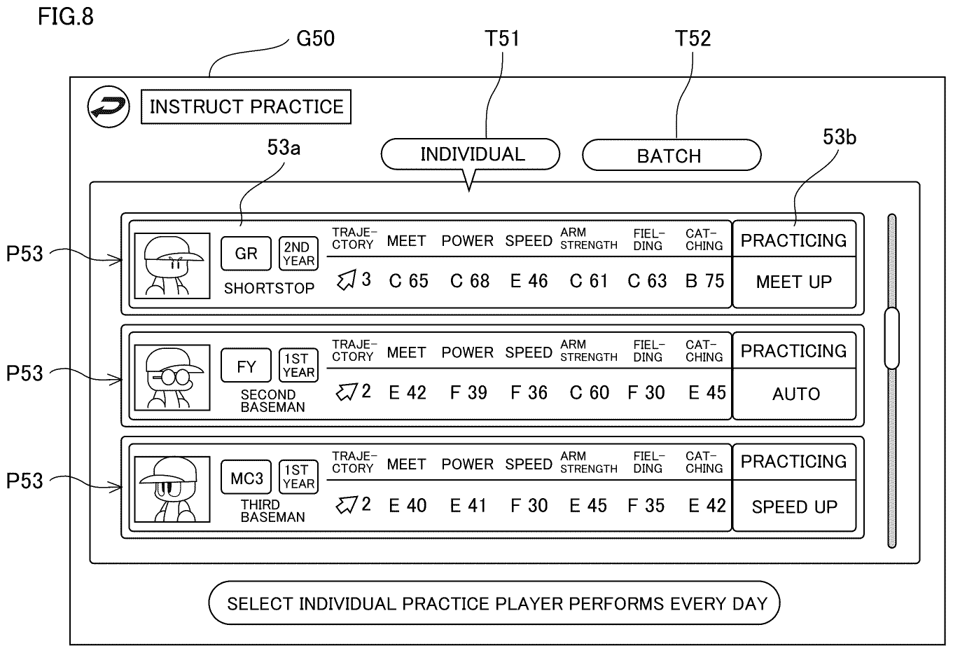

FIG. 8 illustrates an example of the individual practice instruction screen G50. The individual practice instruction screen G50 has an “individual” tab T51 for assigning practice to each player in the team, and a “batch” tab T52 for assigning practice to a group of some players in the team all at once, which the user can select between.

As illustrated in FIG. 8, when the “individual” tab T51 is selected, displayed on the individual practice instruction screen G50, is a plurality of player plates P53 for all players in the team. The player plates P53 not displayed on the individual practice instruction screen G50 can be viewed by scrolling. On the player plate P53 of each player, displayed are the player information such as the image, name, position, school year, and ability of that player, as well as the currently performed practice information 53b. When the user performs an operation of selecting any of the player plates P53 (for example, by tapping), a transition is made to the practice selection screen to select the training to be instructed to the player on the player plate P53.

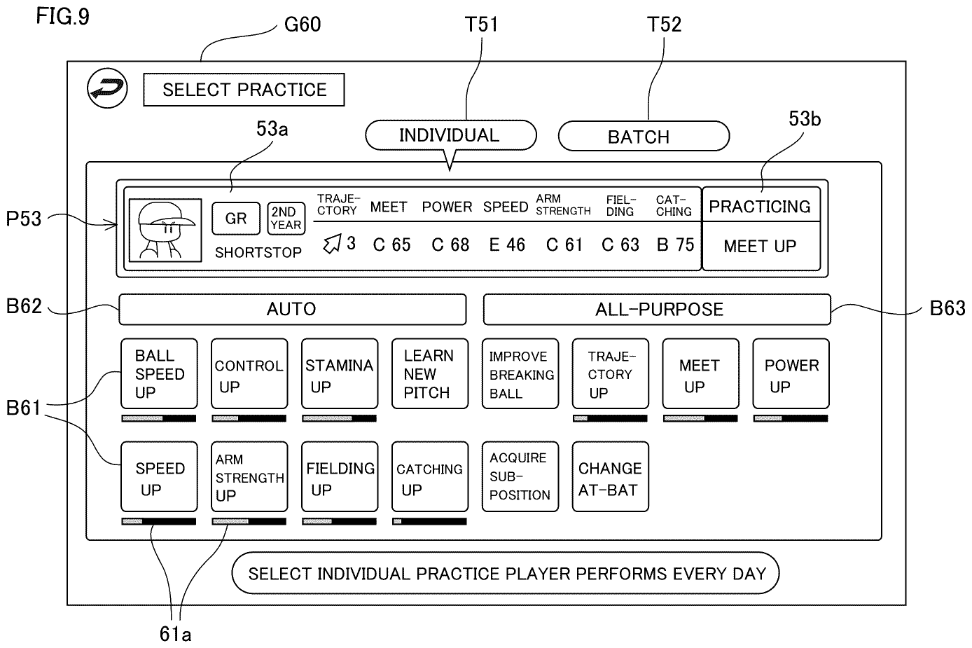

FIG. 9 illustrates an example of the practice selection screen G60. On the practice selection screen G60, displayed is the player plate P53 of the practice target player selected by the user. On the practice selection screen G60, also displayed are a plurality of practice item buttons B61 for the user to select practice items to be instructed to the target player for the practice. The practice item buttons B61 include, for example, practice items of ball speed increase, control improve, stamina increase, trajectory improve, contact hitting improve, power increase, running ability improve, arm strength increase, fielding ability improve, and catching ability improve, and the like. For example, a progress gauge 61a for the target player's running ability is displayed below the “running ability improve” practice item button B61. For this reason, the user can select the practice items while referring to the progress gauge 61a.

Further, the practice item button B61 has practice items for learning breaking balls, playing breaking balls, learning sub-possessions, and changing at-bats. If these exercise item buttons B61 are selected, a transition is made to the practice details setting screen (not illustrated). Then, on the practice details setting screen, the user can set which breaking ball to acquire, which breaking ball to polish up, which secondary position to choose, and which at-bat to choose (right-handed, left-handed, or switch hitter).

Further, the player does not only practice the practice item corresponding to the practice item button B61 selected by the user. For example, when the user instructs a player to improve his running ability, the user instructs the player to practice to improve his running ability over other abilities.

Further, the practice selection screen G60 also displays an auto button B62 and an all-purpose button B63. By selecting the auto button B62, the user can delegate the practice policy for the target player to the game system 1. For players individually instructed for this “automatic” practices, the game system 1 automatically determines practice items based on the predetermined standard.

Further, by selecting the all-purpose button B63, the user can instruct the player the practice policy so that respective abilities of the target player can be improved in a balanced manner. For players who are instructed to practice this “all-purpose” individual practice, the game system 1 automatically determines the practice items so that each player's abilities can be improved approximately evenly. Specifically, a practice for ability with fewer experience points will be selected preferentially.

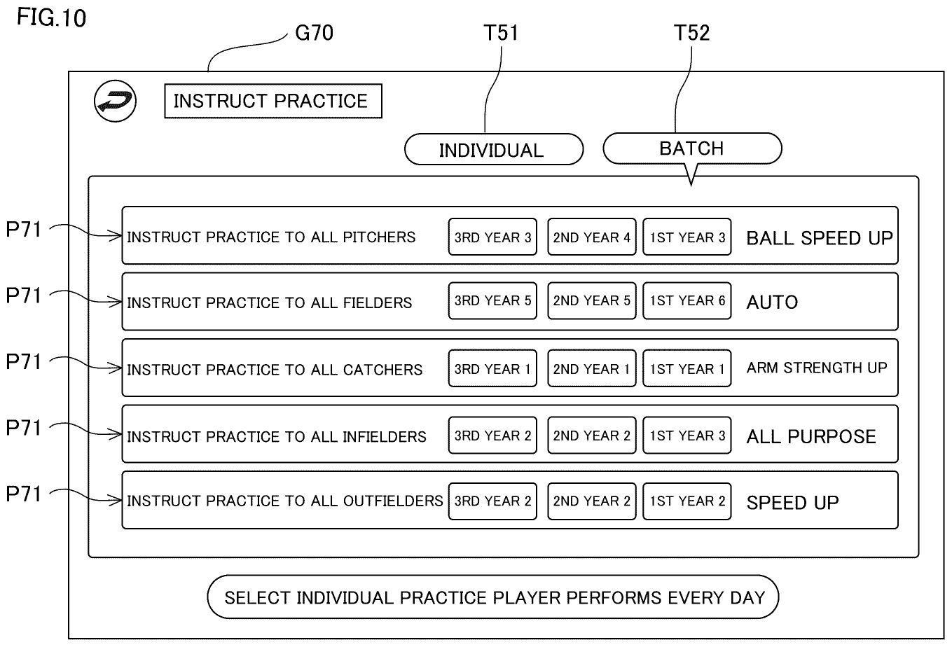

As illustrated in FIG. 10, on the individual practice instruction screen G70 with the “batch” tab T52 selected, at least one group plate P71 is displayed. In the present embodiment, five types of group plates P71 are displayed to instruct individual practice to each of the groups of players: all pitchers, all fielders, all catchers, all infielders, and all outfielders. Here, the all fielders include catchers, all infielders and outfielders. The number of players for each school year included in the target group is displayed on the group plate P71. When the user performs an operation (for example, a tapping) of selecting an arbitrary “group plate P71”, a transition is made to the practice selection screen for selecting the practice to be instructed to the group of players corresponding to the group plate P71.

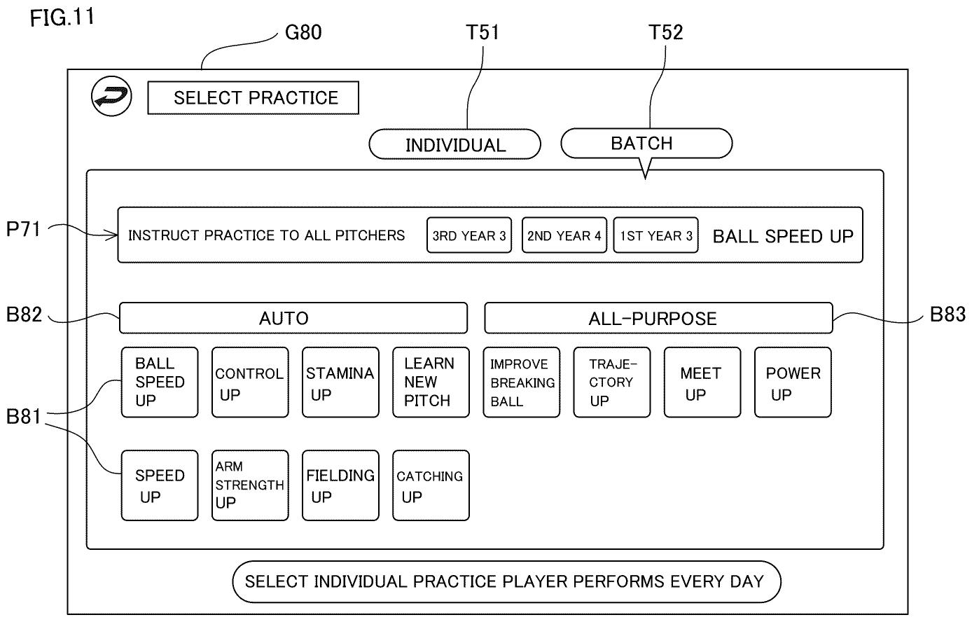

FIG. 11 illustrates an example of the practice selection screen G80 for a selected group of players. The practice selection screen G80 displays the group plate P71 of the player group selected by the user. Further, on the practice selection screen G80, practice item buttons B81, an auto button B82, and an all-purpose button B83 are displayed to select practice items to be instructed for the target group of players. The practice item button B81 has practice items of ball speed increase, control improve, stamina increase, trajectory improve, contact hitting improve, power increase, running ability improve, arm strength increase, fielding ability improve, and catching ability improve, and the like. The practice item buttons B61, the auto button B62, and the universal button B63 of FIG. 9 and the practice item buttons B81, the auto button B82, and the all-purpose button B83 of FIG. 11 only differ in the target range of individual practice instructions, and other than that, both are the same. Between the practice item button B61, the auto button B62, and the all-purpose button B63 of FIG. 9, and the practice item button B81, the auto button B82, and the all-purpose button B83 of FIG. 11, the only difference is whether the individual practice instructions are directed at a single player or a group of players, and are otherwise the same.

In the present embodiment, the example has been given through the case of collectively instructing each of the groups of players: all pitchers, all fielders, all catchers, all infielders, and all outfielders. However, the present invention is not limited to the above example. For example, an individual practice may be instructed collectively for various groups of players, such as all 1^{st} year students, all 2^{nd} year students, all 3^{rd} year students, all regular players, or all bench players.

Once individual practice instructions are set for players, the instructions remain in effect until the settings are changed.

Further, the progress icons P46 include a “practice instruction” icon for instructing the individual practice. In the turn this “practice instruction” icon is displayed, when the “practice instruction” icon is selected, a transition is made to the individual practice instruction screen G50 of FIG. 8, and an individual practice can be instructed to individual players.

### (2-5. Registration of Trained Teams)

Annually (after the farewell party event on September 6th), the user's team at that time can be registered (saved) as a training completed team. In the present embodiment, the number of players that can be registered as a team is a total of 18 players, consisting of 9 starting players and 9 bench players.

After the “farewell party” event, a transition is made to a registered team formation screen, where the user selects nine starting players and nine bench players from a plurality of players within the team, and registers the team. In this case, additional information set by the user, such as the high school name, uniform, school emblem, and team policy, may also be registered. The registered teams are associated with user identification information and stored in the database DB, etc., of the game system 1.

The timing of team registration is not limited to September 6^{th} every year, but can be set arbitrary. For example, the timing of the annual graduation ceremony event in March can be used for the team registration timing.

Additionally, as a variation, a team should be allowed to register all players within the team at the time the training is complete, without limiting the number of players who can be registered as a team.

(2-6. Registration of Training Completed Individual players)

Every year (after the draft meeting event held on October 26^{th}), players who are in their 3^{rd} year in the team at that time and who meet the predetermined registration condition can be registered (saved) as individual characters. For example, the registration condition can be, for example, a predetermined ability value or higher, or a predetermined scout evaluation or higher.

In the present embodiment, at the draft event, up to six players in their 3^{rd} year are selected based on their abilities and scout evaluations. Then, one or more the 3^{rd} year student players who have become draft nominees are registered as professional players. This professional player registration is equivalent to the registration of individual players who completed training. The registered individual players are associated with user identification information and stored in the database DB of the game system 1.

The timing of registration of individual players who have completed training is not limited to October 26^{th} every year, but can be set arbitrary. For example, the timing of registration of individual players may be set to the timing of the graduation ceremony event in March every year.

Further, as a variation, it is possible to allow all the 3^{rd} year student players included in the training completed team to register as individual players who have completed training without setting any registration condition. Alternatively, at least one player arbitrarily selected by the user from among all the 3^{rd} year student players in the training completed team may be registered as individual players who have completed training.

### (2-7. Use of Registered Teams or Individual Players in Different Mode)

The team or individual players registered after the training is complete can be used in game modes different from the training mode. In the present embodiment, the registered teams or individual players can be used in a match mode (an example of the second game). The match modes include a CPU match mode, and a real-time match mode. The CPU match is also called a computer match. The CPU match mode may be given a name such as “stadium”. In this CPU match mode, the user selects the team to be used for the match from among the registered teams, and plays against the opponent's team automatically controlled by the CPU. For example, the opponent team automatically controlled by the CPU is the team trained by other user in the training mode. The real-time match mode is a mode in which the user can communicate and compete online with other user in remote locations via network N.

There are two types of match mode: the first league mode, where a competition can be made using only the teams registered as teams, and the second league mode, where a competition can be made by forming a team from only registered individual players.

The registered teams or the individual players may be used in game modes other than match mode. For example, the registered teams or the individual players may be used in a game mode of creating baseball equipment, etc.

There is an upper limit on the number of teams or the number of individual players that the user can register. If the number of teams or players that can be registered has reached or exceeded the upper limit, a warning will be displayed at the time of the entrance ceremony event (April 8^{th} every year). In this case, the user needs to delete 1 or more of the registered teams or players, to create space for teams to register after the next farewell party event, or for individual players to register after the draft meeting event.

As a variation, the upper limit may not be set for the number of teams or the number of players that can be registered.

### (Graduates not Registered as Individual Players)

Every year, a graduation ceremony event takes place on March7th, where the future careers of the team's graduates (the 3^{rd} year student players) after graduating from high school are decided. The 3^{rd} year student players registered as individual players are confirmed to become professional baseball players. The occupation of each of other graduates is selected by lottery from among a plurality of occupations (career paths after graduation), and after graduating from high school, they are registered as people in town. That is, graduates who have not been registered as individual players are stored as people in town of various occupations in association with the user identification information.

Occupations include, for example, artisans, shop clerks, butchers, office workers, scouts, and so on. After the graduates are registered as townspeople, they may appear as the above character panels for a predetermined period (for example, 3 years in in-game time).

### (2-8. New Student Scout)

The “new student scout” icon P46d may be displayed in the progress icon display area A45 of the progress screen G40 of FIG. 5, the “new student” icon P46d may be displayed. For example, the “new student scout” icon P46d will be displayed through a lottery based on a predetermined appearance probability during the period from November to February. When the user selects and executes the “new student scout” icon P46d, the new student scout event occurs. The new student scout event is an event where users can scout (solicit) new student candidates for the next academic year in advance.

In the present embodiment, the user cannot scout more than ten times a year. The number of times, and the number of new students the user can scout can be set arbitrary.

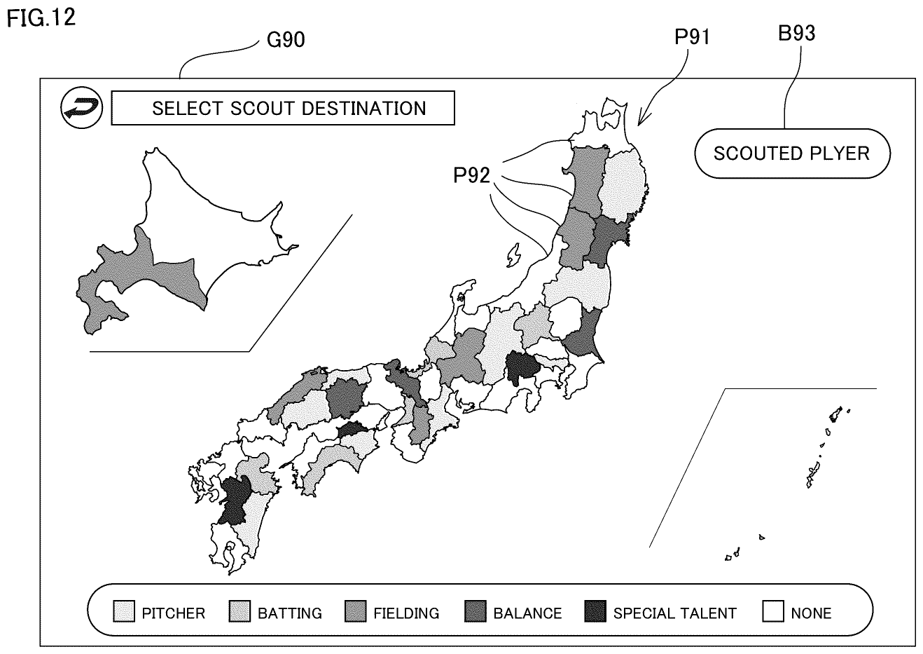

When the user selects and executes the “new student scout” icon P46c, the screen transitions to the scout destination selection screen. FIG. 12 is an example of a scout destination selection screen G90. The scout destination selection screen G90 displays a map P91 for selecting a prefecture as a destination area P92. In each prefecture of the destination area P92, player trend information is displayed that shows the player trends of scout candidates that are popular in that area. The player tendencies are “pitcher”, “batting”, “defense”, “balance”, “special talent”, “nothing special” and the like. Here, the “pitcher” indicates that pitcher training is thriving in that area, and there is a high possibility that pitchers are included as scouting candidates. Similarly, the “batting”, the “defense”, and the “balance” respectively indicate that the batting training, the defense training and the balance improving training are thriving in respective areas, and there is a high possibility that scout candidates with high hitting ability, scout candidates with high defensive ability, and scout candidates with good balance are included in the scout candidates respectively. The “special talent” indicates that the scout candidates whose one ability is superior to other abilities are included in that area with high possibility. The “nothing special” indicates that various types of players are trained in the area, and there is no particular bias in the player tendency.

For example, the player tendency information is information in which each destination region P92 is color-coded according to the player's tendency. A color corresponding to the player's tendency is applied to each destination area P92. Specifically, for example, the colors corresponding to player tendencies are “pitcher (red)”, “batting (green)”, “defense (yellow)”, ‘balance (blue)”, “special talent (purple)”, and “nothing special (white)”.

The player tendency information is not limited to the colors corresponding to player tendencies, but may also be symbols, shapes, letters, etc. corresponding to the player tendencies.

Further, when the user performs an operation of selecting a scouted player button B93 provided on the scout destination selection screen G90, the list of the information of the players scouted so far is displayed.

Based on the current team situation (for example weak in pitching ability, etc.), the user considers the desired type of new students to be joined the team at the next entrance ceremony event. Then, referring to the player trend information displayed on the scout destination selection screen G90, the user can select the destination area P92.

When the user selects the destination area P92, the screen transitions to a scout player selection screen.

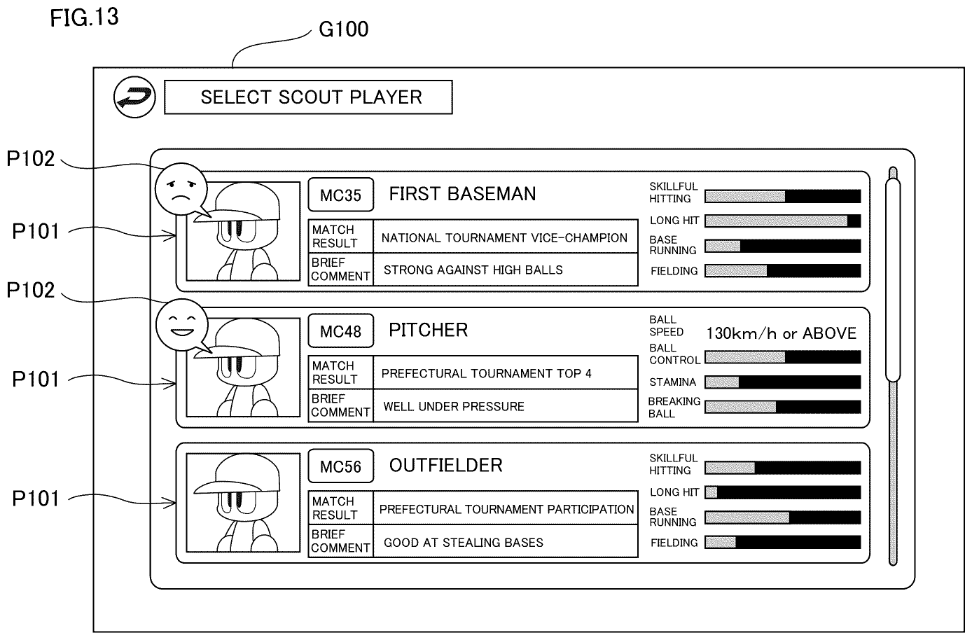

FIG. 13 is an example of the scout player selection screen G100. The scout player selection screen G100 displays the list of selectable scout player candidates P101. The scout player candidates P101 are displayed with the information such as the player's image, name, position, match results, review, ability, etc. The match results include, for example, participation in prefectural tournaments, the best 4 prefectural tournaments, regional tournament participation, national tournament participation, national tournament second place, national tournament championship, etc. Here, the better the record, the higher the ability tends to be. The short reviews are information that suggests the special abilities that a player may have. For example, in the case of a short review of “strong against high balls”, the player may have a special ability “high ball hitter”.

For the scout player candidates P101 that the user has scouted so far, the reaction information P102 when previously scouted is displayed. The reaction information P102 when previously scouted shows the result of the previous scout (the reaction of the scouted player). In the present embodiment, the information of the symbols (for example, facial expressions) corresponding to “good”, “normal”, and “bad” is displayed as the reaction information P102 when previously scouted.

The user can select one of the plurality of scout player candidates P101 they wish to scout from among those displayed in the scout player selection screen G100, thereby scouting the player corresponding to the selected scout player candidate P101. A player scouted by the user is referred to as a “Scouted Player.” In this case, the game system 1 determines the reaction of the scout players to be any one of“good”, “normal” or “bad”. The reaction of the scout player may be determined by a random lottery, or the draw probability may be changed based on the scouted player's parameters. For example, the higher the scouted player's ability, the less likely “good” is to be selected and the more likely “bad” is to be selected (i.e., the higher the ability of the player, the more difficult they are to scout successfully).

The player's reaction to scouting may be changed based on the parameters associated with the user. For example, the lottery probability is changed such that the higher the user's class or the reputation parameter is, the reaction“good” is likely to be selected, and the reaction “bad” is less likely to be selected.

Additionally, it may be arranged such that in the case of scouting the same player multiple times, the current reaction is not worse than the previous reaction.

The information on scouted players scouted by the user (including information on the scout player's reaction) is stored in the database DB, etc., of the game system 1 in association with the user identification information.

According to the player's reaction to scouting, the probability of the scouted player entering the user's high school (i.e., the probability of being able to join the user's team as a new member) at the next entrance ceremony event is different. The order of admission probability, from the highest to the lowest, is “favorable (e.g., 100%)”>“average (e.g., 50%)”>“poor (e.g., 5%)”.

For example, if the admission probability is 100% for the reaction “favorable”, when the entrance ceremony event occurs, a scouted player with the reaction “favorable” will always be displayed as one of the general prospective members in the area A31 of the general enrollment student selection screen G30 as illustrated in FIG. 4. Similarly, if the admission probability is 50% for the reaction “good” will be displayed with a 50% probability as one of the general prospective members in the area A31 of the general enrollment student selection screen G30 as illustrated in FIG. 4.

Please note that there can be a discrepancy between the parameters such as the abilities displayed during the scouting of a player and their actual abilities when they join the team. They are not always the same, but can be the same.

After the entrance ceremony event is complete and the new students have joined the team, the scouted player information associated with the user identification information is reset.

As a variation, even after new students have joined the team, at least one scouted player's information could persist, allowing them the chance to join the user's team in subsequent year's entrance ceremony.

### (2-9. Continued Training Through Changing Teams)

As mentioned above, after the farewell party event on September 6^{th} ends and the team that has completed training has been registered, the 3^{rd} year players of the team do not participate in practice and their abilities therefore do not change. On the other hand, even after the team has been registered, the 1ₛₜ and 2^{nd} student players of the team remain with the team and participate in practice. In other words, in training mode, the registration of the team does not mean that the team will be disbanded; rather, the training of the team begins towards registration on September 6^{th} of next year. When registering the team next year on September 6th, the current 1^{st} year and 2^{nd} year students will be 2^{nd} year and 3^{rd} year students, respectively, and the team will also include 1^{st} first year players who join after the entrance ceremony event.

Annually, 3^{rd} year student players graduate, and new students (including scholarship students and general enrollment students) enroll and join the user's team, thereby rotating the team members.

As described, in the game in the training mode of the present embodiment, it is not segmented into “one game” units (for example, a unit in which the training of one character is complete after a predetermined number of turns). Instead, when some of the characters in the team graduates, other characters enroll, and the training of the training targets (the team or individual characters included in the team) continues eternally.

Further, in the game of the training mode of the present embodiment, the 1^{st} year student player (referred to as player A) included in the training completed team registered in a certain year may belong to the training completed team registered in the next year as the 2^{nd} year student player (in the state more trained than that in the previous registration). Furthermore, the player A may also belong to the training completed team as a 3^{rd} year student player in the following year (in a still more trained state than at the time of the previous or the time before previous registration).

### (2-10. Consumption of Action Points)

For example, the initial upper limit of “action points” displayed in the display area A42 of the progress screen G40 of FIG. 5 is “30”, and the upper limit varies according to a supervisory level (described later) such that the higher the supervisory level is, the higher is the upper limit. As a variation, the upper limit of the action points may be constant (unchanged).

In the training mode of the present embodiment, the required amount of action points is consumed when extending into the next month to progress the game. The required amount of action points at the consumption timing can be set arbitrarily. In this embodiment, the required amount is set to “10”.

In the example in FIG. 5, if today is the turn of ‘December 28th’ and a progress icon P46 with progress days information P47 within “3” is selected in that turn, the month transition will not occur (remain in the current month). On the other hand, if the progression icon P46 with progression days information P47 of “4” or more is selected in that turn, the process will not extend into the next month.

Namely, the number of in-game time days that progress in one turn differs depending on the progress day information P47 of the selected progress icon P46. Thus, the number of in-game time days that progress in one turn differs depending on the progress day information P47 of the selected progress icon P46. Therefore, even within the same turn, depending on the progress day information P47 of the selected progress icon P46, there may be or may not be a turn that extends into the next month, that is, a consumption timing.

For example, assume a case where, in the turn illustrated in FIG. 5, the user performs an operation to confirm the selection of a progress icon P46 with the progress days information P47 of “5”. In this case, when executing the command of the selected progress icon P46, a month transition to the next month occurs in the turn. Namely, since the turn where the month transition into the next month occurs is the consumption timing of the action points, it is determined whether the required amount of action points of “10” or more remains before executing the command of the progress icon P46. Here, if it is determined that the required amount of action points of “10” or more remains, the command for the selected progress icon P46 is executed, provided that the required action points “10” is consumed. Furthermore, in that turn, the required amount of action points may be reduced (consumed) before or after the command of progress icon P46 is executed, or after all the events in that turn end.

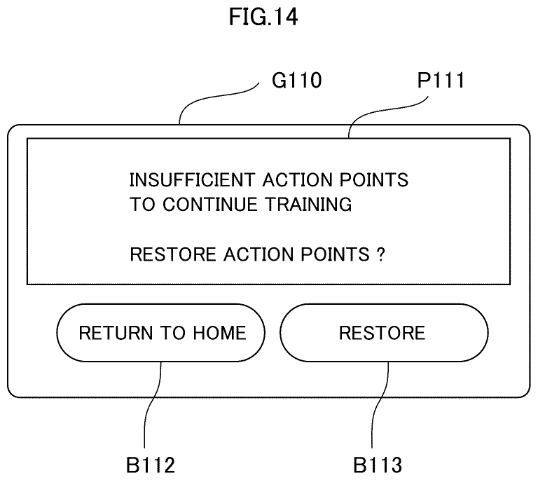

On the other hand, if it is determined that the action points are less than the required amount of “10” in the turn of the action points consumption timing, an insufficient action point notification window G110 of FIG. 14 is pop-up displayed on the progress screen G40. On the insufficient action point notification window G110, for example, a message P111 “Insufficient action points to continue training. Restore the action points?”, a “Return to Home” button B112, and a “Restore” button B113 are displayed. If the user selects the “Return to Home” button B112, the training mode will be interrupted, and the screen goes back to the home screen. On the other hand, if the user selects the “Restore” button B113, the screen for selecting items (including paid items) to restore the action points is displayed.

### [2-11. Restoring Action Points]

The action points, even when consumed, are naturally restored over time. For example, it recovers by 1 point every 6 minutes. Additionally, the action points can be restored by using recovery items or paid items (it will not be restored beyond the upper limit).

Additionally, the action points are restored to the upper limit (maximum amount) every time the supervisory level increases (level up). As a variation, the action points may be increased only by a predetermined amount (preferably more than the required amount) when the supervisory level rises.

### [2-12. Supervisory Level]

The supervisory level is the level of the manager character as the user's avatar, or in other words, the user's game level. The initial value of the supervisory level at the start of the game is “1”. A user executes the game and earns experience points as a manager (hereinafter referred to as “manager experience points”). Each time the earned manager experience points reaches the required amount, the supervisory level increases by one. The higher is the supervisory level, the greater is the amount of experience points required to level up. For example, the amount of experience points required to level up the supervisory level from “1” to “2” is “30”, and the amount of experience points required to level up the supervisory level from “2” to “3” is “70”. As a variation, the amount of experience points required for the supervisory level to level up may be constant irrespectively of the supervisory level.

The experience points of the manager can be obtained by consuming the action points in the training mode (or progressing the game by consuming the action points in the training mode). In the present embodiment, the experience points of the manager can be obtained by “5” each time the action points are consumed. Since the action points are consumed in the turn that extends into the next month, the manager experience points are acquired at the same timing as the consumption timing of the action points in that turn.

It may be configured that the manager experience points may also be obtainable by meeting a predetermined condition in a game mode different from the training mode. For example, each time the user plays a match in match mode, using either a registered team or a team composed of registered individual players, a predetermined amount of the manager experience points can be obtained.

### (2-13. Advance Recovery of Action Points at Consumption Timing)

As mentioned above, the manager experience points can be obtained by consuming the action points in the turn of consumption timing of the action points, that extends into the next month. Therefore, there is a limited specific case where the experience points of the manager reach the required experience points and the supervisory level increases if the action points are consumed in the turn that extends into the next month. In such specific case, with an increase of the supervisory level, the action points are restored to the upper limit. In this specific case, if the amount of the action points is insufficient for the required amount in the turn that extends into the next month, and a user uses a paid item or the like to restore the action points to execute that turn, there is a concern that the user might feel the action points recovered with the paid item or the like were wasted when the supervisory level is increased, and the action points are fully restored.

Therefore, in the above specific case where by consuming the action points in a turn that extends into the next month (an example of the consumption timing), the supervisory level will be raised, the advance processing is executed to restore the action points to the upper limit by increasing the supervisory level before consuming the action points in that turn. As a result, even when the action points are insufficient in the turn that extends into the next month, the action points can be fully restored automatically to the upper limit without requiring a user to use a paid item, etc., and it is possible to execute the game in that turn.

In the case where the above advance processing is performed, the following adjustment to action points will be performed after the game progresses through the execution of the turn that extends into the next month.

Specifically, in the case where the action points before being recovered through the advance processing are insufficient for the required amount of “10” (i.e., less than 10), after executing the turn that extends into the next month, the insufficient amount is consumed from the action points which have been restored through the advance processing (i.e., from the maximum action points). As a concrete example, in the case where the action points before been restored by the advance processing is “3”, since the insufficient amount is “7”, the action points are reduced by “7” from the maximum value after executing the turn that extends into the next month. In this way, by automatically restoring the action points in advance by the advance processing, the action points can be borrowed in advance.

On the other hand, if the action points are not insufficient for the required amount of “10” before being restored by the advance processing (i.e., 10 or larger), the action points will fully recover up to the upper limit after executing the turn that extends into the next month.

As a variation, it may be configured that the actions points are fully restored to the maximum amount after executing the turn that extends into the next month, irrespectively of the action points before being restored by the advance processing.

As another variation, regardless of the action points before being restored through the advance processing, after the turn that extends into the next month is executed, the action points are consumed by the required amount “10”.

In the case where the advance processing is performed, it is preferable to notify the user that action points are restored through the advance processing before or after executing the advance processing. In this way, the user can recognize that the benefit from advance processing has been received. For example, when notifying the user before executing the advance processing, a cut-in performance, etc., may be displayed for the notification before executing the turn that extends into the next month. For example, when notifying the user after executing the advance processing, the notification that the action points were restored beforehand through the advance processing may be made along with the execution results report for that turn after executing the turn that extends into the next month (for example, after all the events in that turn end).

### [3. Functional Configuration of Game System]

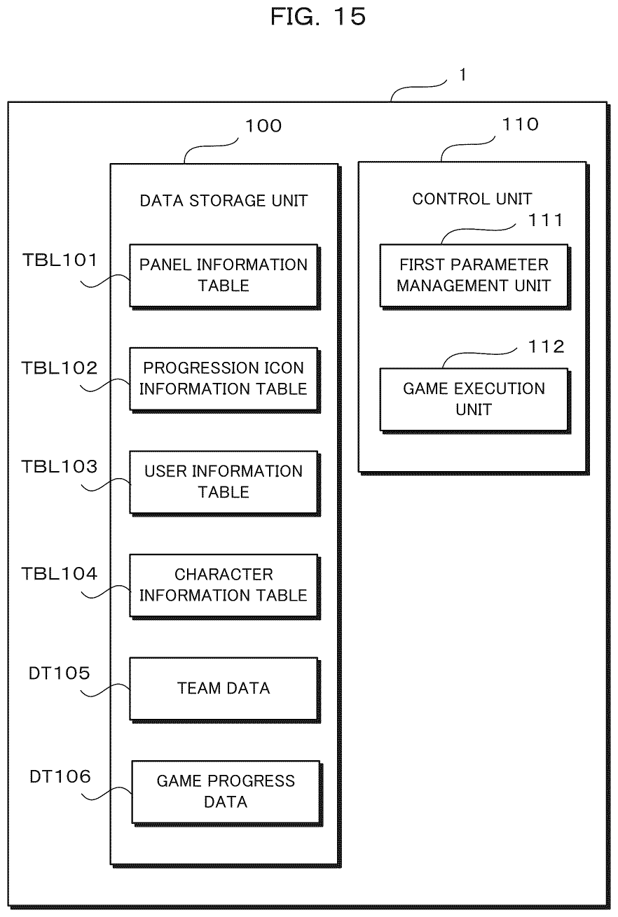

FIG. 15 is a schematic functional block diagram illustrating an example of a functional configuration of the game system 1. As illustrated in FIG. 15, the game system 1 includes a data storage unit 100. For example, the data storage unit 100 is realized by at least one of the database DB, the ROM 12, the RAM 13, the auxiliary storage device 14, the ROM 32, the RAM 33, and the auxiliary storage device 34. The data storage unit 100 stores data necessary for providing the game.

For example, various data for executing a game stored in the data storage unit 100 are stored in the database DB or the auxiliary storage device 34 of the server 30, and when the game terminal 10 accesses the server 30, the necessary data can be downloaded to the RAM 13 or the auxiliary storage device 14 of the game terminal 10. Further, the information on the results of the game executed by the game terminal 10 and changes in data are transmitted from the game terminal 10 to the server 30 in real time or at a predetermined timing, and the data stored in the database DB or the auxiliary storage device 34 of the server 30 can be updated as appropriate. Further, for example, at least a part of the game may be stored in the auxiliary storage device 14 of the game terminal 10, etc., so that the game can be executed offline without logging in to the server 30 in the game terminal 10 of each user.

As a specific example of the data stored in the data storage section 100, the necessary data to provide the above baseball game will be described. The data storage unit 100 stores a panel information table TBL101, a progress icon information table TBL102, a user information table TBL103, a character information table TBL104, a team data DT105, a game progress data DT106, etc.

The panel information table TBL101 (see FIG. 6) and the progress icon information table TBL102 (see FIG. 7) have already been explained, so the descriptions thereof shall be omitted here.

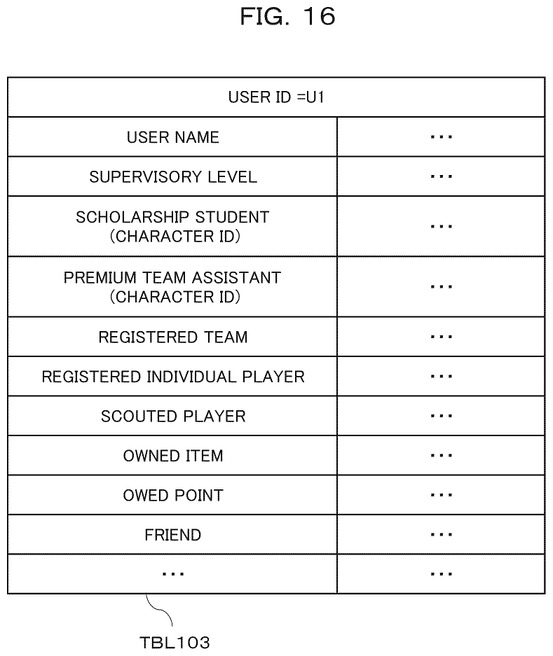

FIG. 16 illustrates one example of the user information table TBL103. In the example of FIG. 16, the user information table TBL103 storing information for a single user with the user ID “U1” is shown; however, the user information table TBL103 covering all users registered with the game system 1 is stored in the data storage unit 100 of the game system 1 (for example, in the database DB, the auxiliary storage device 34, or the like).

In the user information table TBL103, stored in association with the user ID of each user, are the user names, the supervisory level (the game level of the user), the information of scholarship students in possession, the information on the premium team assistants in possession, the information of the registered team after the training is complete, the information of the registered individual players after the training is complete, the information of owned items, the information of owned points, the information of other users (friends) associated with the user ID of the user, etc.

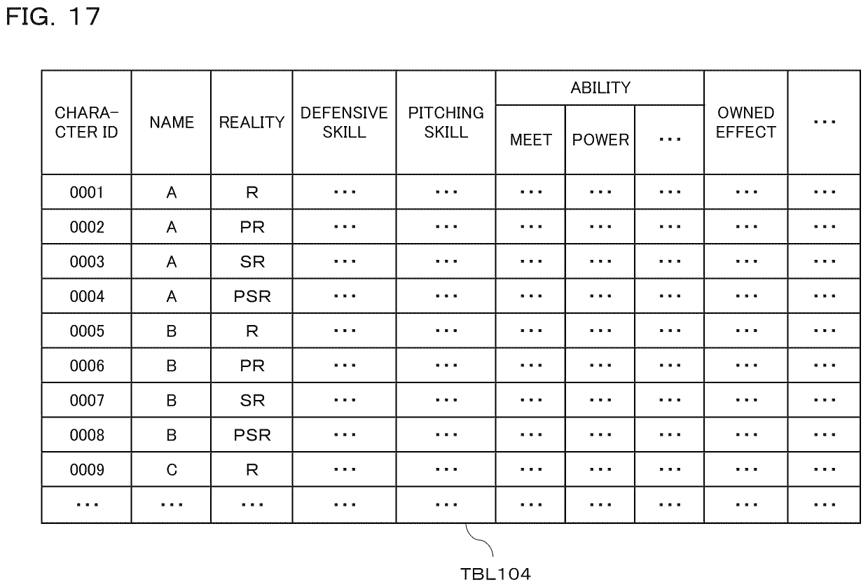

FIG. 17 illustrates an example of the character information table TBL104. The character information table TBL104 is master data for managing all the scholarship student characters handled within the game provided by the game system 1. The character information table TBL104 stores the initial value data of all scholarship students. For example, the character information table TBL104 is stored and managed in the respective storage devices of the server 30 and the game terminal 10 (for example, the RAM 13, the auxiliary storage device 14, the RAM 33, the auxiliary storage device 34, the database DB, etc.). The character information tables TBL104 respectively stored in the server 30 and the game terminal 10 are basically the same, and for example, when the game operator changes the character information table TBL104 on the server 30, the changed information is transmitted from the server 30 to the game terminal 10 via the network N.

The character information table TBL104 includes fields such as “character ID”, “name”, “rarity”, “defensive aptitude”, “pitching aptitude”, “ability”, and “possession effect” of each scholarship student. The character ID is an identification information that uniquely identifies a character in the game.

Although omitted in FIG. 17, the character information table TBL104 also stores the information of other characters than the scholarship students (premium team assistants, etc.) used in the game.

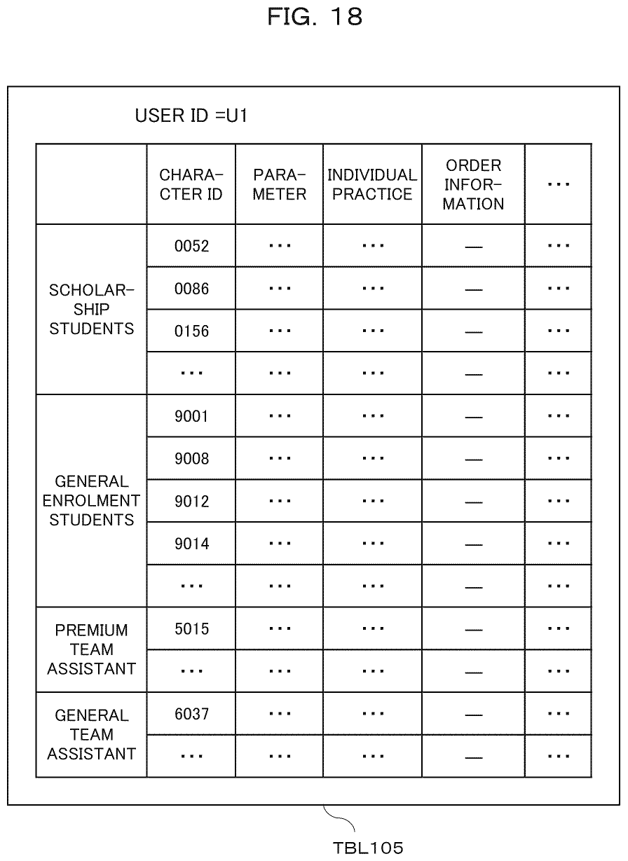

FIG. 18 illustrates an example of the team data DT105. The team data DT105 is the information of the team as the training target in the training mode. The team data DT105 is stored for each user (in association with the user ID). The team Data DT105 includes information such as a team rank, reputation, and overall team strength, etc. The team data DT105 includes information on parameters such as the character IDs of the scholarship students, the general enrollment students, the premium team assistants, and the general team assistants included in the team, as well as the abilities of each character. Additionally, the team data DT105 includes information on individual practices that the user instructs each player in the team. The team data DT105 also includes the order information of the team (the information identifying starting members, on-bench members, and off-bench members, the positions, the batting order, etc.).

For the game progress data DT106, stored are, for example, the information of the current turn (the information on today's date in-game time, a plurality of progress icons P46 displayed on the screen, players participating in practice, etc.), and the information of the plurality of panels P44 displayed on the screen, etc.

The game system 1, the server 30 or the game terminal 10 of the present embodiment executes the control of the game for training the training target by changing or setting the parameter(s) of the training target based on the user's operation.

Here, the “user” is, for example, a person who plays the game by operating a game terminal. For example, user identification information is set for each user or each game terminal operated by the user, and each user is identified (specified) by the user identification information.

The “user identification information” refers to information used to uniquely identify each user. For example, a user ID, a unique username, or an email address corresponds to an example of the “user identification information”.

The “training target” is an object or a group including a plurality of objects, the parameter(s) of which is changed or set as the game progresses based on the user's operation. The “training target” may be at least one object, or at least one group, or both.

Here, the “object” is something that can be used in the game. For example, game characters, game cards, etc. correspond to examples of the “object”. For example, game characters and game cards representing people such as baseball players, soccer players, and other athletes, animals such as racehorses, plants such as trees and flowers, fictional creatures such as monsters, and non-living things such as robots, are examples of “objects.” For example, the “object” may be a game character or game card that corresponds to a real person or animal, or it may not correspond to a real person or animal.

In the above example of the baseball game, each player included in the team (including scholarship students, general enrollment students, premium team assistants, and general team assistants) corresponds to an example of the “object.”

The “changing a parameter” refer to changing the parameter set to the object. For example, to improve or reduce the parameter set to the object correspond to one example of “changing a parameter”.

To set a parameter” refers to, for example, to assign a parameter to an object that has not yet been set for that object. For example, adding a special ability that an object did not previously possess to that object (e.g., associating information about a special ability with the object) is an example of “setting a parameter”. “Setting a parameter” includes not only setting a parameter that produces an advantageous effect but also setting a parameter that produces a disadvantageous effect.

In the above example of the baseball game, changing the ability parameters of the plurality of players included in the team as the training targets by a practice command or an event corresponds to one example of “changing a parameter”. Further, applying a special ability (special ability with an advantageous effect or disadvantageous effect) to multiple players included in the team by a command of practice, etc., or an event corresponds to one example of “setting a parameter”.

As illustrated in FIG. 15, the game system 1 includes a control unit 110. The control unit 110 is realized by executing a game program stored in the storage device (the ROM 12, the RAM 13, the auxiliary storage device 14, the ROM 32, the RAM 33 or the auxiliary storage device 34, etc.) by the CPU 11 of the game terminal 10 or the CPU 31 of the server 30. Here, some of the functions of the control unit 110 may be realized by the CPU 11 of the game terminal 10, and the remaining functions may be realized by the CPU 31 of the server 30. Alternatively, all the functions of the control unit 110 may be realized by the CPU 31 of the server 30, or all the functions of the control unit 110 may be realized by the CPU 11 of the game terminal 10.

The control unit 110 includes a first parameter management unit 111 and a game execution unit 112.

The first parameter management unit 111 has a function of managing a first parameter associated with user identification information and necessary for executing the game for training the training target.

Here, the “first parameter” is the game parameter necessary for executing the game for training a training target. The first parameter may be given any arbitrary name, such as cost, compensation, action points, stamina, physical strength, AP, EP, or the like.

The first parameter management unit 111 can be configured to have a function that, when the first parameter is consumed, gradually restores the first parameter to the upper limit over time. As a variation, the first parameter may not be restored over time.

The first parameter” may be fully restored to the upper limit or recovered by a predetermined amount by using a paid item, a recovery item, points, in-game currency, or the like, or it may not be restored by the paid item or the like. The first parameter may also be fully restored to the upper limit or restored by a predetermined amount if a predetermined recovery condition in the game (e.g., the user's game level exceeding a predetermined standard) is satisfied.

In the above example of the baseball game, the action points required for executing a command, such as a practice command, etc., of the target of the user's team, that is managed in association with the user ID, corresponds to one example of the “first parameter”.

The game execution unit 112 has the function of executing the game for training the training object at least at one consumption timing set after the start of the training for the training target, on the condition that the required amount of the first parameter is consumed.

Here, the “consumption timing” refers to the timing when the first parameter is consumed.

Regarding “at least at one consumption timing set after the start of the training for the training target”, the consumption timing is set after the start timing of the training of the training target. The consumption timing may be provided a plurality of times or only one time after the start of the training for the training target.

For example, the plurality of consumption timings set from the start to the completion of the training, or the consumption timing set only once from the start to the completion of the training, correspond to one example of the “at least one consumption timing set after the start of the training for the training target”.

For example, setting the timing at which the training of a training target is complete as the consumption timing of the first parameter corresponds to an example of “at least one consumption timing set after the start of the training for the training target. In this case, the first parameter takes the form of a post-payment. For example, a limit on the number of post-payments may be set, such as once a day or three times a week in the real world. Alternatively, conditions for post-payment may be established (e.g., the user's game level reaches a predetermined standard, or a predetermined game result is achieved in a game mode different from the training mode).

For example, a consumption timing set once or multiple times after the completion of the training for the training target corresponds to an example of “at least one consumption timing set after the start of the training for the training target”. In this case as well, the first parameter takes the form of a post-payment. Here, the above limits on the number of possible post-payments and conditions for post-payments may be set. In this post-payment mode for the first parameter, it is also possible to adopt a mode (that is, an automatic deduction mode) in which the first parameter, which naturally recovers over time (for example, while the user is interrupting the game, such as during sleep), is automatically consumed at consumption timings set at predetermined time intervals.

Regarding the “required amount of the first parameter”, the required amount can be set arbitrarily, which can be constant (fixed) or variable. For example, the required amount may be constant no matter how many times a training game for a single training target is played (even in the case where a training is repetitively performed, such that after a training is complete, another training is performed), or the required amount may increase or decrease as the number of times the training game is played increases. Furthermore, when multiple consumption timings are provided after the start of the training, the required amount of the first parameter for each timing may be constant, or may increase or decrease with each subsequent timing.

Regarding “executing a game for training a team on a condition that the required amount of the first parameter is consumed”, in the case where at least one consumption timing is set from the start to the completion of the training, the game can be progressed by executing the game for training the training target after the start of the training till the consumption timing. After the consumption timing, however, unless the required amount of the first parameter is consumed at the consumption timing, the game for training the training target cannot be executed. In the case a plurality of consumption timings are set before the completion of the training, unless the required amount of the first parameter is consumed at each consumption timing, thereafter the game cannot be progressed.

On the other hand, in the case where the consumption timing is set the timing at or after the training target is complete (i.e., post-payment is permitted), the game cannot proceed thereafter unless the required amount of the first parameter is consumed at each consumption timing. However, since the consumption of the required amount of the first parameter is the condition for executing the game, the required amount of the first parameter is consumed at the consumption timing set at or after the completion of the training. For example, in the case where the first parameter is insufficient for the required amount at the consumption timing set at or after the completion of the training, the restrictions may be set so that the training targets that have completed training cannot be registered or used until the required amount of the first parameter is consumed. Alternatively, for example, a restriction may be set such that the game for training the next training target cannot start until the required amount of the first parameter is consumed.

In the above example of the baseball game, the game execution unit 112 has the function of executing a game for training a team on the condition that the required amount of action points is consumed at least at one consumption timing set after the start of the training of the user's team. As a result, even when the action points are insufficient at the start timing of training, it is possible to start the training game, and to progress the game at least to some extent. Therefore, the burden on the user of executing (particularly, starting) the training game can be reduced. For example, in the case of the action points which can be restored over time, or using a paid item, etc., the wait time for the recovery of the action points, or payment can be reduced, thereby reducing the burden on the user. As a result, the user can start the training game without feeling too burdened, and it is therefore possible to avoid fading the user's desired to start the game.

Further, it may be configured such that on the condition that the first parameter of the required amount is consumed, the game execution unit 112 executes the game for training the training target respectively at each of a plurality of consumption timings set from the start to the completion of the training for the training target.

Here, the period from the start timing to the completion timing of the training (hereinafter referred to as a “training period”) may be always constant (for example, one year of in-game time, etc.), or may vary depending on the training target. For example, for the training target of a group such as a baseball team, the training period can be set to one year, and for the training target of an individual object (for example, a player character belonging to the baseball team), the training period can be set to 3 years. Further, the training period may vary depending on the attribute of the object (or the attributes of the team), for example, if the player character is the 3^{rd} year high school student, the training period can be set to one year, the 2^{nd} year high school student, the training period can be set to two years, and the 1^{st} year high school student, the training period can be set to three years.

Regarding the “plurality of consumption timings set from the beginning to the completion of the training”, the number of consumption timings can be set arbitrarily. For example, a consumption timing can be set at intervals such as every day, every week, every month, or every year, based on either in-game time or real-world time. For example, if the consumption timing is set every month of in-game time, the timing of extending into the next month (when the month changes to the next month) can be used as the consumption timing. Alternatively, the timing including the first day or the last day of each month of in-game time, and the middle day of each month (for example, every 15th), etc. can be set as the consumption timing.

The consumption timing may be set regularly at fixed intervals, such as every month of in-game time (or real-world time). Alternatively, the intervals may not always be constant but follow a certain rule, for example, every week for the first three months from the start of training, every two weeks for the next three months, and every month thereafter. The interval between consumption timings can be set longer or shorter as the game progresses. For example, the interval between one consumption timing and the next consumption timing may be determined based on the probability (for example, at random) each time.

The consumption timing may be determined based on in-game time, or real-world time.

In the above example of the baseball game, the timing that the in-game month extends into the next month is defined as the consumption timing. In this example, the consumption timing of the first parameter is set every “one month” of in-game time.

As an example of defining the consumption timing according to real-world time, the timing that the real-world month extends into the next month may be defined as the consumption timing. Specifically, if the consumption timing is set to midnight (00:00 AM) on the first day of every month in real-world time, it is necessary to consume the first parameter when the game is executed after midnight on the first day of the month. In this case, the consumption timing of the first parameter is set every “one month” of real-world time. This example can be described as a subscription model in which a user can play a game (or a game mode) for a predetermined period (which is one month in the above example, but may be one day, one week, etc.).

The “progress of the game” refers to that the game progresses by executing the game based on the user's operations to progress the game. The “progress of the game for training the training target” refers to that the game progresses by executing the game based on the user's operations for training the training target. For example, in a turn-based game where s turn advances due to user operations, the execution of turn processing according to the user's operations is one example of the “progress of the game”. The game may be progressed by a predetermined period such as one day, one week, etc., in-game time each turn. In other words, the game can be such that the number of turns required from the beginning to the completion of training is fixed. Also, the degree of progress in one turn may vary for each turn. For example, the game progresses only one day, or three days or five days, etc. in game-time according to the command selected by the user.

In the above example of the baseball game, the game progresses by selecting command options such as “practice” (progress icons P46) for each turn, and the processing for the selected practice or the like is executed.

In the above example of the baseball game, the game execution unit 112 executes the game in the training mode on condition that the required amount of action points is consumed at each timing of extending into the next month (an example of the plurality of consumption timings) set from the beginning to the completion of the training for the team of the training target. According to this configuration, the training game can be progressed step-by-step by consuming action points at each of the plurality of consumption timings after the training starts, instead of consuming a large amount of action points all at once when starting the training of the training target. By consuming the total action points required from the beginning to the completion of training in small increments at each consumption timing, the amount of action points needed at one time can be reduced. This reduces the burden on the user to play the training game.

The training target can be a group including a plurality of affiliated objects.

Here, the “affiliated object” is an object affiliated with (included in) the group.

The “group” is a group consisting of two or more affiliated objects. The “group” can also be, for example, a team, a collective, a troop, a party, a guild, etc. For example, in the case of a sports simulation game that simulates baseball, soccer, or other sports games, a team that includes a plurality of player characters as “affiliated objects” is an example of the “group”. Further, games that use animals such as racehorses, plants such as trees and flowers, fictional creatures such as monsters, or non-living objects such as robots, etc., a party, in which a plurality of objects are included as “affiliated objects”, corresponds to examples of the “group”.

In the above example of the baseball game, the training target is a team that includes a plurality of players which can be trained in group units.

The group may include a first affiliated object selected by the user from among owned objects associated with the user identification information, and a second affiliated object other than the owned objects.

Here, the “owned object” is defined to be an object owned by the user in the game, which is stored in association with the user identification information. Examples of the “owned object” include an object obtained by a user through a lottery in lottery mode (so-called gacha), an object obtained as a reward by meeting a certain condition in the game (for example, winning a match), an object received as a gift from other user or in exchange with other user, etc. The user can selectively use any owned object in the game.

The “first affiliated object” is at least one owned object selected by the user from among the owned objects in the group of the training target (for example, a baseball team).

The “second affiliated object” is an object other than the owned object(s) included in the group of the training target. For example, an object such as a mob character generated by the game system can be one example of the second affiliated object. Additionally, an object selected by the game system by lottery from among the objects managed in the game can be an example of the second affiliated object.

In the above example of the baseball game, the user's team (an example of the group) includes a scholarship student selected by the user from among the scholarship students (an example of the first affiliated object) associated with the user ID and a general enrollment student (an example of the second affiliated object) who is a mob character generated by the game system 1. With this configuration, the objects arbitrarily selected by the user from among the objects (scholarship students) owned by the user can be included in the plurality of players constituting the user's team. By having users acquire various objects in advance, the degree of freedom in the composition of the team of the training target can be increased.

Further, the training target can be both the group and individual affiliated objects in the group.

In the above example of the baseball game, the training targets are both the team made up of a plurality of players (including scholarship students and general students) and individual players (the scholarship students or the general students) included in the team. As a result, while training the team of the training target team by team, individual players in the team (group) can be trained as well as the training targets.

Further, the game execution unit 112 may be configured to have the function of accepting a batch instruction operation for training of a plurality of affiliated objects in the group as well as an individual instruction operation for training each of the plurality of affiliated objects.

Here, the “batch instruction operation for training” is an instruction operation for training that a user can perform collectively on a plurality of affiliated objects included in the group. The batch instruction can be for all the plurality of affiliated objects in the group or for some of the plurality of affiliated objects in the group. Specifically, the batch instruction may be for all the pitchers in the baseball team, or for all the fielders, etc.

The “individual instruction operation for training” is an instruction operation for training that can be performed individually by a user for each of the plurality of affiliated objects in the group.

The batch instruction operation or the individual instruction operation may include, for example, instructions for practice or matches, as well as instructions for learning (gaining knowledge), resting (relieving fatigue), and going out/playing (changing pace).

The batch instruction operation or the individual instruction operation for training may be an operation for instructing a training policy (practice policy, etc.). For example, in the case of a baseball game, practice policies such as “focus on batting”, “focus on running speed”, or “focus on fielding skill” may be instructed at a predetermined timing or an arbitrary timing, or the practice policy may be changed.

In the example of the above baseball game, the game execution unit 112 accepts an operation to collectively instruct practice or the like for a plurality of players included in the team (an operation to select and execute the above progress icon P46), and accepts an operation to individually instruct practice or the like for each of the plurality of players (the above individual practice instruction operation). This makes it possible to provide team-based training for multiple players collectively, while also allowing for individual training that brings out the unique personality of each player within the team, thereby realizing a highly entertaining and interesting game.

Furthermore, the plurality of affiliated objects included in the group may be configured to include affiliated objects with mutually different remaining periods until training is complete.

Here, “affiliated objects with mutually different remaining periods until training is complete” includes any of the following cases (1) to (3):
(1) Affiliated objects, the start timing of the training of which is the same, but the training periods of which are different from each other, so the remaining periods until the completion of the training are different. For example, in the case of the high school baseball team, and for the first year of the game, the training periods are different for the 1^{st} year student (about 3 years until graduation), the 2nd year student (about 2 years until graduation), and the 3V year student (about 1 year until graduation).
(2) Affiliated objects, the training period of which is the same, but the remaining periods before the completion of the training of which are different. For example, in a high school baseball team, new 1^{st} year students join the team every year. However, players are at different stages of their three-year training period, with 1^{st} year students starting their training, 2^{nd} year students having started one year earlier, and 3^{rd} year students having started two years earlier.
(3) Affiliated objects, both the training periods of which and remaining periods before the completion of the training of which are different. For example, in the case of the high school baseball team, transfer students and mid-year recruits (any of the 1^{st} to 3^{rd} year students) can join the team in a different month than the typical enrollment month of for example, April.

In the above example of the baseball game, the team has the players respectively having different remaining periods until the completion of the training (the above (1) to (3), etc.). It is therefore necessary to instruct the training of the entire team or the training of the individual players while considering the remaining period of each player. As a result, it is possible to realize a highly entertaining and interesting game.

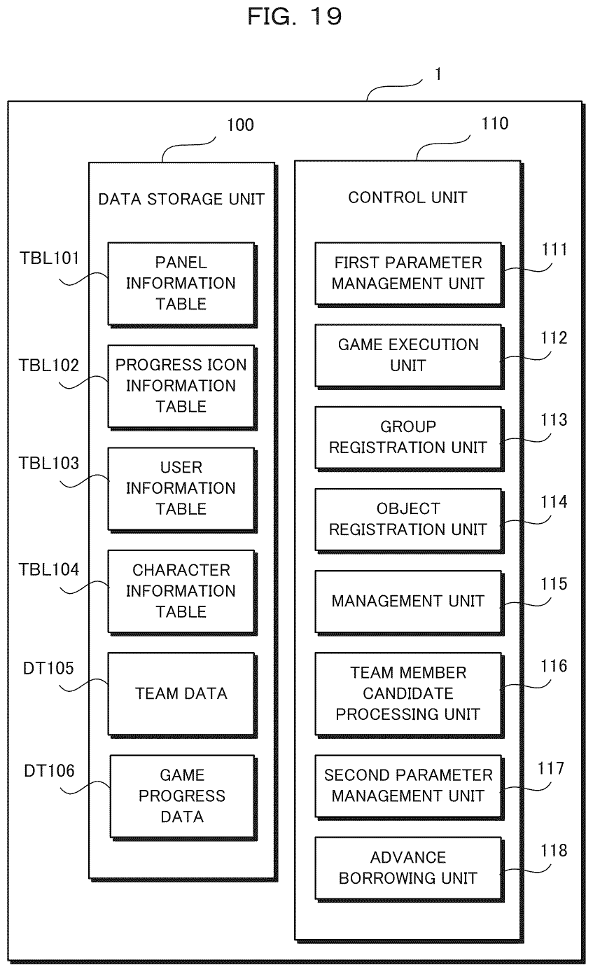

As illustrated in FIG. 19, the control unit 110 may include a group registration unit 113 and an object registration unit 114.

The group registration unit 113 has a function of registering the group, after the training of the group is complete, as a group usable in a second game different from the game for training the training target, in association with user identification information.

The object registration unit 114 has a function of registering, after the training of at least one of a plurality of affiliated objects included in a group is complete, the affiliated object for which the training has been completed as an object usable in the second game in association with user identification information.

Here, the “second game” can be any game other than a game for training a training target (referred to as a “training game”) regardless of its genre or specifications. Each of the training game and the second game may be a part of one game, or they may be separate games. For example, one game mode among a plurality of game modes executed by one game program corresponds to an example of the “training game”, and another game mode among them corresponds to an example of the “second game.” Alternatively, the training game may be executed by a first game program, and the second game may be executed by a second game program.

In the above example of the baseball game, after the training of the team (an example of the group) is complete (after the farewell party event on September 6^{th} ends), the group registration unit 113 registers the team in association with the user identification information as a team that can be used in a match mode (an example of the second game) different from the mode of the training game. Similarly, after the training of the 3^{rd} year student players in the team is complete (after the draft meeting event on October 26^{th} ends), the object registration unit 114 registers in association with the user identification information some of the 3^{rd} year student players (players who meet the prescribed registration condition) as individual players that can be used in the match mode different from the mode of the training game. With this configuration, even after the training is complete, the user can still enjoy the second game using the registered team or individual players. This allows the user to enjoy the second game using the registered team or individual players even after the training is complete. In particular, both team-based registration and individual player-based registration are possible, and since the second game can be enjoyed using either one or both, the game variations are expanded.

It may be further configured such that the timing of registering the group that has completed training by the group registration unit 113 and the timing of registering an individual affiliated object that has completed training by the object registration unit 114 are different.

In the above example of the baseball game, the timing at which the training completed team is registered by the group registration unit 113 is after the farewell party event occurring on September 6^{th}. On the other hand, the timing at which training completed individual players are registered by the object registration unit 114 is after the draft meeting event occurring on October 26, which is different from the team's registration timing. This allows the user to continuously enjoy playing the second game, different from the training game, without getting bored, for example, by using the team after being registered, or using the individual players after being registered.

As illustrated in FIG. 19, the control unit 110 may include a management unit 115. This management unit 115 has a function that, each time the training of a group including a plurality of affiliated objects is complete, enables the repeated training of the group while partially replacing the plurality of affiliated objects, by excluding only a portion of the plurality of affiliated objects from the group and adding new affiliated objects to the group.

In the previous example of the baseball game, the management unit 115 makes it possible to repeatedly train a team while partially replacing the multiple players of the team by, each time the training of the team including a plurality of players (the 1^{st} to the 3^{rd} year students) is complete, removing only the 3^{rd} year players from the team and newly adding freshmen players to the team. This allows for a continuous and endless repetition of team training, realizing a highly engaging and entertaining training game.

As illustrated in FIG. 19, the control unit 110 may include a member candidate processing unit 116. This member candidate processing unit 116 has a function of presenting the user a plurality of candidate objects that can be candidates for a new affiliated object before the new affiliated object joins the team, and determining the probability that the candidate object selected by the user from among the plurality of candidate objects can be the new affiliated object.

In the above example of the baseball game, in the new student scout event, the member candidate processing unit 116 presents the user with a plurality of scout player candidates P101 (an example of the candidate object) who can become candidates for a new student player before the new student player (an example of the new affiliated object) joins the team (see FIG. 13), and determines the probability that the scout player candidate P101 selected by the user from among the plurality of scout player candidates P101 can become a new student player. This allows the user to pre-select and scout candidates for the new student players for the team before the new student players officially join the team, which enhances the gameplay of the training game.

As illustrated in FIG. 19, the control unit 110 may include a second parameter management unit 117. The second parameter management unit 117 has the function of managing the second parameter that can be improved as the game progresses by consuming the first parameter. Further, it may be configured that the first parameter management unit 111 has the function of restoring the first parameter by a predetermined amount or to the upper limit when the second parameter improves above a predetermined standard.

Here, the “second parameter” is the game parameter associated with the user identification information, which improves as the game progresses by consuming the first parameter. For example, the experience points of the user that increases as the game progresses by consuming the first parameter, or the user level that increases each time the experience points meet a predetermined standard, correspond to examples of the “second parameter”. Further, in the case where the experience point of the avatar character (so-called player character) increases as the game progresses by consuming the first parameter, and the character level increases each time the experience points meet a predetermined standard, the experience points or the character level of that character corresponds to examples of the “second parameter”.

In the above example of the baseball game, the supervisory level, or the experience points of the manager to improve the supervisory level corresponds to an example of the “second parameter”.

In the above example of the baseball game, the second parameter management unit 117 manages the supervisory level (or the experience points of the manager) that can be improved as the game progresses by consuming the action points. Then, the first parameter management unit 111 restores the action points by a predetermined amount or to the upper limit when the supervisory level (or the experience points of the manager) improves above a predetermined standard. With this configuration, if the supervisory level (or the experience points of the manager) increases by consuming the action points, and the supervisory level increases above the predetermined standard, the action power can be restored by a certain amount or to the upper limit. It is therefore possible to reduce the burden on the user.

As illustrated in FIG. 19, the control unit 110 can be configured to include an advance processing unit 118. The advance processing unit 118 has a function of executing advance processing to restore the first parameter by a predetermined amount or up to an upper limit by improving the second parameter above the predetermined standard, before consuming the first parameter at the consumption timing, if it determines that the second parameter will improve above the predetermined standard if the game progresses by consuming the first parameter at the consumption timing.

Regarding the phrase, “the game progresses by consuming the first parameter”, either the consumption of the first parameter or the progress of the game by the execution of the game may occur first, or both may occur substantially simultaneously. For example, the first parameter may be consumed before the game is executed, or the first parameter may be consumed after the game is executed.

In the above example of the baseball game, if the advance processing unit 118 determines that the supervisory level will increase (an example where the second parameter increases above the predetermined standard) by consuming the action points (an example of the first parameter) in the turn of consumption timing, that extends into the next month, the action points are restored by the predetermined amount or up to the upper level by increasing the supervisory level before the action points are consumed in the turn of consumption timing. As a result, at the specific consumption timing, that the action points are restored by increasing the supervisory level when the game progresses by consuming the action points at the consumption timing, a user can proceed the game without using a paid item, etc. Thus, it is possible to prevent in advance a situation in which a user feels that an unnecessary charge or the like has been made.

The first parameter management unit 111 may be configured such that if the first parameter, before the second parameter is improved by the advance processing unit 118, is insufficient for the required amount by an insufficient amount, after the game progresses, from the first parameter which has been restored by the advance processing unit 118, the insufficient amount is consumed.

In the above example of the baseball game, the first parameter management unit 111 is configured such that if the action points, before the supervisory level is increased by the advance processing unit 118, is insufficient for the required amount (for example, shortage of “7”), after the game progresses, the insufficient amount is consumed from the action points that has been restored (for example, restored to the maximum) by the advance processing unit 118 (in this example, the action points are consumed by “7” from the maximum). According to this configuration, the advance processing unit 118 essentially performs an advance borrowing (recovery) of the shortfall in action points, allowing the user to proceed with the game without making payments (e.g., charging), and the shortfall in action points that was borrowed in advance can be offset after the game progresses. This makes it possible to realize a game that provides the user with a sense of satisfaction.

Furthermore, the first parameter management unit 111 may be configured such that, if the first parameter is not insufficient for the required amount before the second parameter is improved by the advance processing unit 118, the first parameter may be restored to the state restored by the advance processing unit 118 after the game progresses. In the above example of the baseball game, if the action points before the advance processing are not insufficient, the action points are fully restored to the maximum after the month changes (extending into the next month).

As a variation, the first parameter management unit 111 may be configured to restore the first parameter to the maximum after the game progresses, regardless of the first parameter value before the second parameter is improved by the advance processing unit 118 (i.e., regardless of whether it is insufficient for the required amount).

Alternatively, as another variation, the first parameter management unit 111 may be configured such that the first parameter is brought into a state where a required amount (for example, “10”) is consumed after the game progresses, regardless of the value of the first parameter before the second parameter is improved by the advance processing unit 118.

### 4. Processing

Next, an example of the processing performed by the game system 1 of the present embodiment will be described below. Here, an example of the processing of the game system 1 that executes the above-described baseball game will be described.

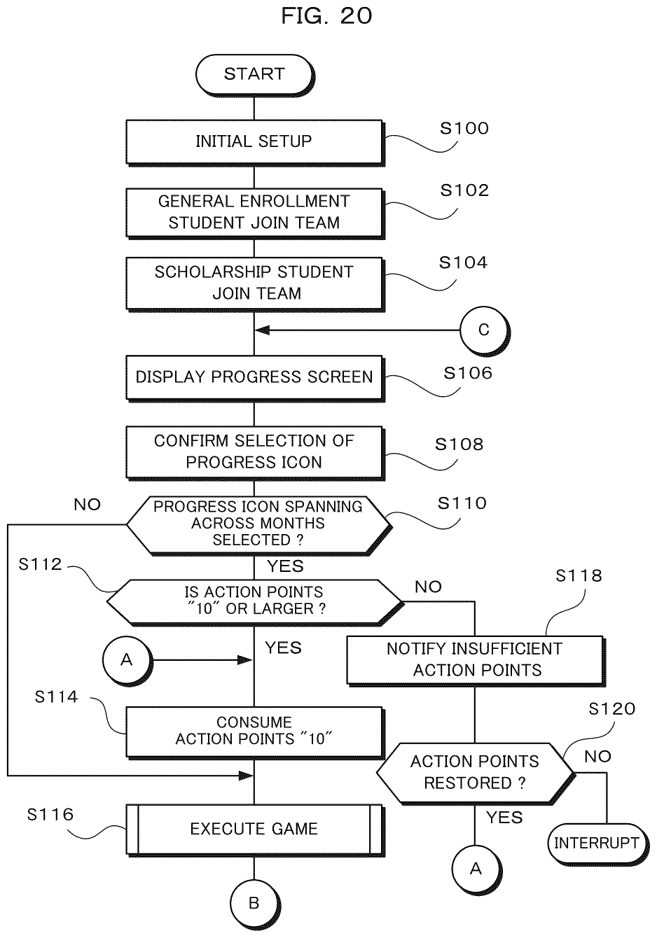

FIG. 20 to FIG. 25 are flowcharts illustrating an example of the processing of the game system 1 that executes the training mode. The below-explained processes are realized, for example, by the control unit 110 (the CPU 11 of the game terminal 10 or the CPU 31 of the server 30) which executes a game program stored in the storage device (the ROM 12, the RAM 13, the auxiliary storage device 14, the ROM 32, the RAM 33, the auxiliary storage device 34, etc.).

In the training mode of the present embodiment, after the training starts, the action points are consumed by “10”, each time the month changes to the next month. Furthermore, the game can be executed without consuming the action points at the start of the game (the start of training in the first year is April, for example April 1st or April 8th, etc.).

As illustrated in FIG. 20, before starting the game in the training mode, the user performs initial settings of information such as the area, the high school name (S100). The control unit 110 stores the information initially set by the user ID in the user information table TBL103 in association with the user.

Furthermore, in the initial year of the game, the control unit 110 generates a plurality of general enrollment 1^{st} year, 2^{nd} year, and 3^{rd} year students who are mob characters and has them join the user's team (S102). Here, the user may be allowed to select the general enrollment students from among the plurality of candidates for general enrollment students as generated. Alternatively, it may be configured that in the first year of the game, general enrollment students generated by the control unit 110 can join the user's team without the user's selection operation.

Additionally, the control unit 110 adds a predetermined number of scholarship students, selected by the user from among the scholarship students owned by the user, to the user's team (S104).

Although omitted in FIG. 20, the control unit 110 adds a team assistant (either a general team assistant or a premium team assistant) to the user's team.

The control unit 110 then stores the information of the players and team assistants who have joined the user's team in the team data DT105.

Although omitted in FIG. 20, the user can set the team lineup (order). The team order information is also stored in the team data DT105.

Thereafter, the control unit 110 displays the progress screen G40 (see FIG. 5) on the display unit 17 (S106). Here, the control unit 110 displays a plurality of progress icons P46 on the progress screen G40 and places a plurality of panels P44 on the map A43. Further, the control unit 110 determines the practice participating players 48a from among the plurality of players in the team according to the plurality of progress icons P46 to be displayed, and displays the practice participating players in the practice participation player display area A48. Then, the control unit 110 stores in the game progress data DT106, the information of the plurality of progress icons P46, the plurality of panels P44 and the practice participating players to be displayed on the progress screen G40.

The user selects and confirms one of the plurality of progress icons P46 displayed on the progress screen G40 (S108). The control unit 110 then determines if the progress icon that extends into the next month is selected (S110). If NO in S110, the sequence moves to S116, and the control unit 110 executes the game. After the game starts, the game progresses without extending into the next month, and without consuming the action points for a while until May.

On the other hand, if the progress icon that extends into the next month is selected (YES in S110), the control unit 110 determines if the action points are “10” or larger (S112). If YES in S112, the control unit 110 consumes the action points by “10” (S114) to execute the game (S116).

If the action points are less than “10” (NO in S112), the control unit 110 pops up the insufficient action point notification window G110 (see FIG. 14) on the display unit 17 to notify the user of the lack of action points (S118). If the user restores the action points using a paid item or the like (YES in S120), the process proceeds to step S114. On the other hand, if the user does not restore the action points (NO in S120), the control unit 110 interrupts the training process and saves the game data. Thereafter, when the training is resumed, the process restarts from the progress screen display of step S106.

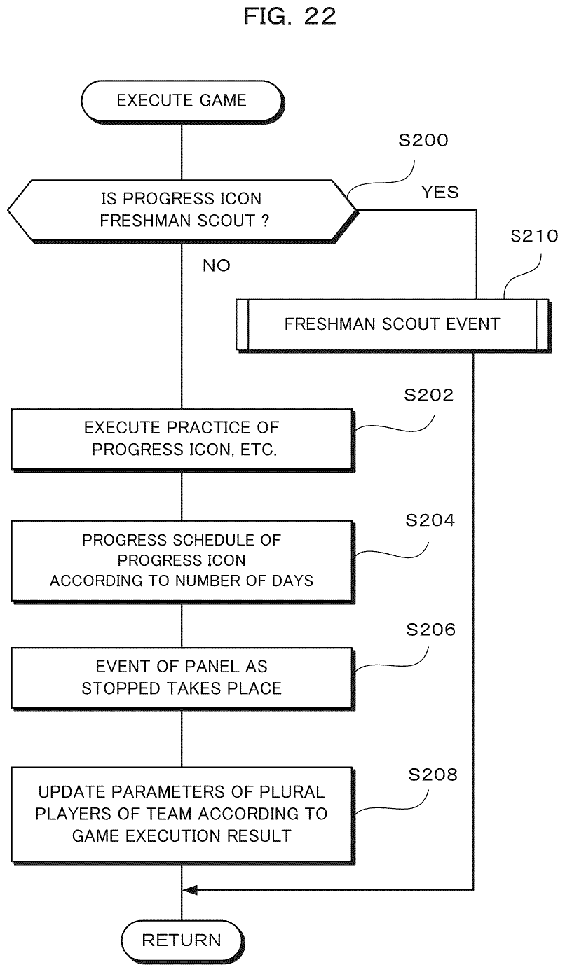

Here, an example of the “game execution” process in the above step S116 is explained in reference to FIG. 22.

In S200, the control unit 110 determines if the progress icon P46 selected by the user is a new student scout. If YES in S200, a new student scout event occurs (S210). The process of the new student scout event will be described in details later.

On the other hand, if the progress icon P46 selected by the user is not the new student scout but a progress icon P46 for practice or the like (NO in S200), the control unit 110 executes the command for practice or the like associated with the progress icon P46 (S202). This collectively instructs practice or the like for the plurality of players included in the user's team. In this case, practice or the like is instructed for the number of days indicated by the progress days information P47 (see FIG. 5) displayed on (associated with) the progress icon P46 selected by the user. Therefore, the greater the number of days in the progress days information P47, the greater the experience points for abilities that the plurality of players within the team can acquire through practice or the like. Furthermore, among the plurality of players in the team, the practice participating players 48a displayed in the practice participation player display area A48 of the progress screen G40 can acquire more experience points for abilities than the other players.

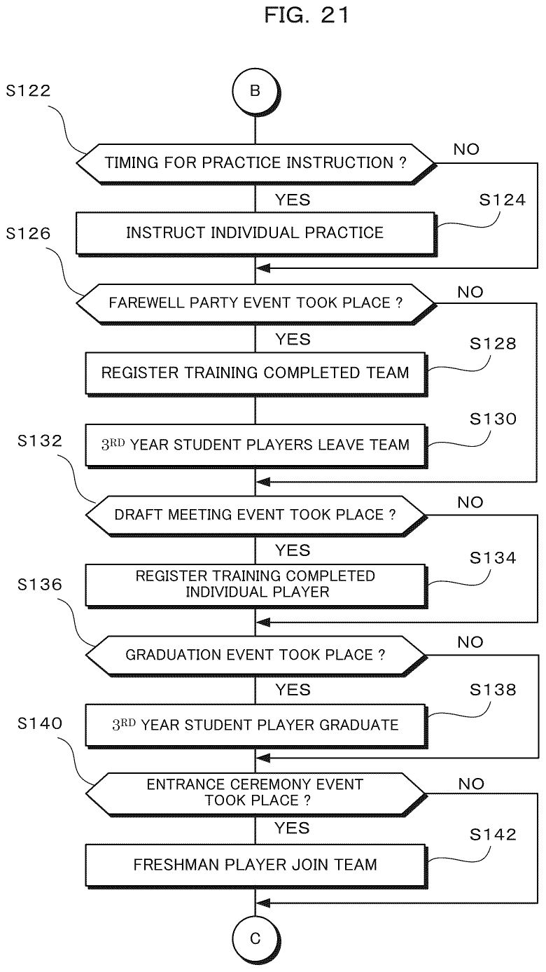

The control unit 110 advances the in-game time schedule by the number of days indicated in the progress days information P47 selected by the user (S204). This causes the panels P44 (squares) on the map A43 of the progress screen G40 to advance by that number of days. The control unit 110 then generates an event associated with the panel P44 landed (S206). Thereafter, the control unit 110 updates the parameters such as the abilities of the plurality of players in the team according to the results of the game execution in this turn (the results of team practice, events, etc.), and stores them in the team data DT105 (S208). The process then moves to step S122 in FIG. 21.

In step S122, the control unit 110 determines if it is a timing at which an individual practice instruction can be given to each player in the team. In this game, individual practice instructions are possible at the beginning of each month (at the timing of extending into the next month), and the control unit 110 determines if the current turn is a turn that extends into the next month. IfYES in S122, the control unit 110 displays the individual practice instruction screen G70 (see FIG. 10) on the display unit 17 and accepts the user's operation of the individual practice instruction (S124). The control unit 110 stores information on the individual practice instruction for each player in the team in the team data DT105.

After S124, or if NO in S122, the process proceeds to step S126.

In Step S126, the control unit 110 determines whether a farewell party event has occurred in the current turn (that is, whether it is the timing for the completion of training for the training target). If YES in S126, the control unit 110 registers the eighteen players selected by the user from the plurality of players within the team (nine starting players, nine bench players) as the training completed team (S128). For example, the control unit 110 stores the information of the training completed team in the user information table TBL103 in association with the user ID. The team registered here can then be used in a match mode, etc., which is different from the training mode.

In addition, the control unit 110 causes the 3^{rd} year student players to leave the current team at the completion of their training, and from that point on, they no longer participate in team practice and their abilities do not fluctuate (S130). This means that the training of the individual 3^{rd} year student players is also complete.

Further, once the training is complete, the 3^{rd} year student players will leave the current team, and the training of a new team, which excludes those 3^{rd} year student players, will start.

In this game, the registration timing of individual players is after the draft meeting event. As a variation, the team registration and the individual player registration may occur at approximately at the same time. As another variation, it may be configured to allow the parameters, such as the abilities of 3^{rd} year student players, to fluctuate even after they leave the team, thus providing an opportunity to train the individual 3^{rd} year student players until the timing of their individual registration. For example, after a farewell event, a national representative team for an international tournament can be formed, and the 3^{rd} year student players could participate in this representative team, thereby improving the parameters such as the abilities of the participating players.

After S130 or if NO in S126, the process proceeds to S132.

In S132, the control unit 110 determines if a draft meeting event has occurred (i.e., if it is the registration timing for individual players) in the current turn. If YES in S132, the control unit 110 registers the player(s) from among the team's 3^{rd} year students who have become draft nominees (who have satisfied a predetermined registration condition) as individual players whose training is complete (S134). For example, the control unit 110 stores the information of the individual players whose training is complete in the user information table TBL103, in association with the user ID. The individual players registered here can then be used in a match mode or the like, which is different from the training mode.

After S134, or if NO in S132, the process proceeds to S136.

In S136, the control unit 110 determines if a graduation ceremony event has occurred in the current turn (i.e., if it is timing to graduate the 3^{rd} year student players). If YES in S136, the control unit 110 graduates the 3^{rd} year players (S138). Note that the graduated students who were not registered as individual players are stored in association with the user ID as townspeople of various professions, and may appear in the training mode of the game.

In this game, the townspeople are graduates of general enrollment students or general team assistants, and the graduates of scholarship students or premium team assistants will not be townspeople. As a variation, the graduates of the scholarship students or the premium team assistants may also appear in the game as townspeople.

After S138, or if NO in S136, the process proceeds to Step S140.

In S140, the control unit 110 determines if an entrance ceremony event has occurred in the current turn (i.e., whether it is a timing to have new student players join the team). If YES in S140, the control unit 110 displays the new member screen G10 (see FIG. 2) on the display unit 17, and accepts the user's operation of selecting and setting the players who will join as new students, and has the new student players join the user's team (S142). The control unit 110 stores the information of the players who joined as new students in the team data DT105. Although omitted in FIG. 21, the control unit 110 can also have a new team assistant (a general team assistant or a premium team assistant) join the user's team. As a result, new student players are added to the team of the training target from which the 3^{rd} year student players of the previous year have been excluded, and the team is replaced.

After S142, or if NO in S140, the sequence goes back to S106 of FIG. 20, and the control unit 110 updates the plurality of progress icons P46, the panels P44, or the practice participating players 48a, etc., displayed on the progress screen G40, and displays the progress screen G40 for the next turn. For example, the progress icon P46 selected in the previous turn is deleted, and a new progress icon P46 is selected by lottery to be included in the plurality of progress icons P46 to be displayed. Then, the control unit 110 updates the game progress data DT106.

In this way, the team members are replaced annually as the 3^{rd} year students graduate and new students enroll and join the team of the training target, ensuring the continuous training of the targets (either the team or individual players in the team).

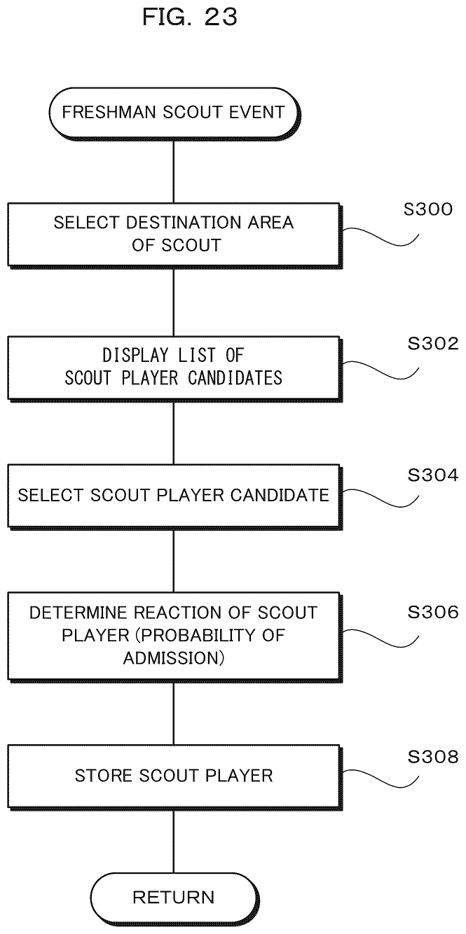

Next, an example of the processing of the “new student scout event” in S210 of FIG. 22 will be explained in reference to FIG. 23.

In S300, the control unit 110 (the member candidate processing unit 116) displays the scout destination selection screen G90 (see FIG. 12) on the display unit 17, and accepts the operation by the user of selecting the scout destination area. After that, the control unit 110 causes the display unit 17 to display a list of scout player candidates P101 (see FIG. 13) who can be scouted in the scout destination area selected by the user (S302). Then, by the user selecting one player to scout from among the plurality of scout player candidates P101 (S304), that selected scout player candidates P101 can be scouted. The control unit 110 determines the reaction of the scouted player as one of “good (e.g., 100% chance of enrollment)”, “normal (e.g., 50% chance of enrollment)”, or “bad (e.g., 5% chance of enrollment)” (S306). Then, the control unit 110 stores the information of the scouted player in the user information table TBL103 in association with the user ID (S308).

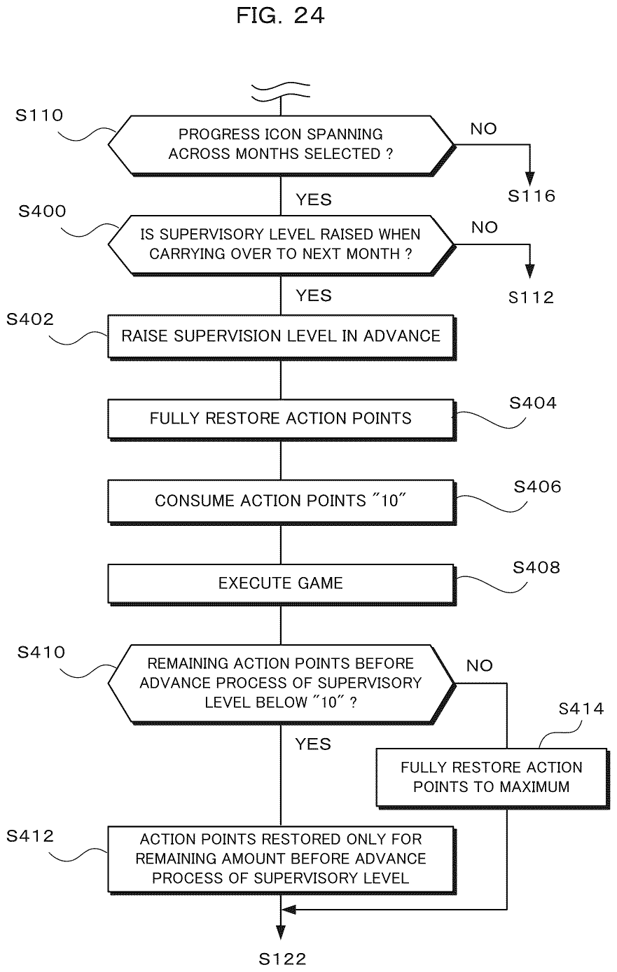

Next, as a modified example of the flowcharts illustrated in FIG. 20 and FIG. 21, an example of the flowchart of the advance processing that can be executed is shown in FIG. 24.

In the example of FIG. 24, if YES in S110 of FIG. 20 (when selecting the progress icon that extends into the next month), the control unit 110 (advance processing unit 118) determines if the supervisory level will increase when extending into the next month (S400). If NO in S400, the sequence moves to S112 of FIG. 20. On the other hand, if the control 110 determines that it is a specific case in which the supervisory level increases when extending into the next month (YES in S400), the advance processing is executed to increase the supervisory level in advance before consuming the action points (S402). As a result, since the action points are fully restored to the maximum (upper limit) (S404), upon selecting the progress icon that extends into the next month in the current turn, regardless of the remaining action points, the user can progress the game without using a paid item or the like.

Thereafter, the control unit 110 consumes the action points by “10” (S406), and executes the game (S408). The game execution process in S408 is similar to the game execution process illustrated in FIG. 22. Note that the order of execution of S406 and S408 may be reversed, or they may be executed substantially simultaneously.”

Thereafter, the control unit 110 determines if the remaining action points before the advance processing is less than “10” (S410). If YES in S410, the action points are restored by the remaining amount prior to the advance processing (S412). As a concrete example, it is assumed that the remaining amount of the action points before executing the advance processing is “3” and the insufficient amount is “7” for the required amount “10”. In this case, after the action points are fully restored to the maximum by executing the advance processing in S404, the game is executed by consuming the action points by “10” (S410). In S412, the action points are restored only for the remaining amount “3” before executing the advance processing. As a result, the action points after executing the game are consumed by “7” (for the insufficient amount before the advance processing) from the maximum.

On the other hand, if the remaining amount of the action points before the advance processing are “10” or larger (NO in S410), the control unit 110 restores the action points to the maximum (S414).

After S412 or S414, the sequence goes to S122 of FIG. 21.

### 5. Modifications

The present invention is not limited to the above-described embodiments.

Each configuration of the embodiments described above may be applied in combination as appropriate, and some configurations may be omitted. For example, in the configuration example of the game system 1 illustrated in FIG. 19, when executing the game that omits the new student scout event or the advance processing, the member candidate processing unit 116 or the advance processing unit 118 may be omitted.

[5-1]

In the above, shown is the example wherein in the above specific case that the supervisory level will increase when the action points are consumed in the turn that extends into the next month, the advance processing is executed automatically regardless of the remaining action points. However, the advance processing may be executed only when the action points are insufficient for the required amount.

[5-2]

As explained above, in the above specific case, the advance processing may be executed automatically without any user operation. However, the advance processing may also be executed only after confirming the necessity of the advance processing with the user and receiving an operation from the user indicating that he/she desires the advance processing.

To provide a concrete example, in the above specific case where the action points are insufficient for the required amount, a notification window would be displayed with explanatory text such as, “Action points are insufficient to continue training. However, the supervisory level is about to level up and the action points will be restored shortly, so the insufficient action points will be borrowed in advance to proceed to the next month.” This notification window would be displayed instead of the insufficient action point notification window G110 of FIG. 14. The user then can choose whether to continue the training by borrowing the insufficient amount in advance or to return to the home screen (interrupting the game in the training mode).

[5-3]

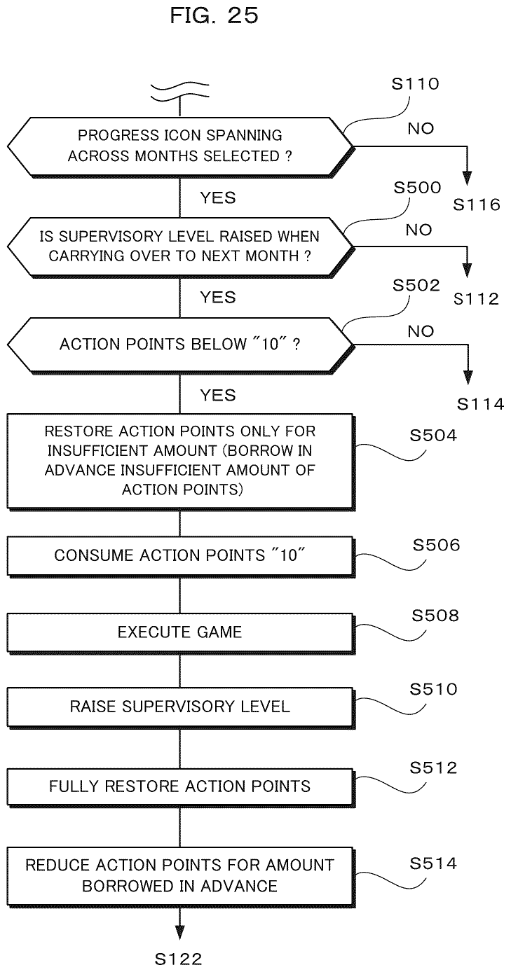

In the above, explanations have been given through the configuration wherein in the above specific case, the action points are restored by increasing the supervisory level in advance before consuming the action points. However, it is also acceptable to have a configuration that allows borrowing the insufficient amount of action points without prematurely increasing the supervisory level. An example of the processing in this configuration will be explained below in reference to FIG. 25.

In the example of FIG. 25, if YES in S110 of FIG. 20 (when a progress icon that extends into the next month is selected), the control unit 110 (advance processing unit 118) determines whether the supervisory level will increase when extending into the next month (S500). If NO in S500, the process moves to S112 of FIG. 20. On the other hand, if the control unit 110 determines that it is a specific case where the supervisory level will increase when the month extends into the next month (YES in S500), the control unit 120 determines whether the current action points are less than 10 (S502). If NO in S502, the process moves to S114 of FIG. 20. On the other hand, if YES in S502, the control unit 110 executes an advance-borrowing process to restore the action points by the insufficient amount for the required amount, before consuming the action points (S504). This is a pre-borrowing process that restores only the minimum necessary shortfall of the action points in advance, rather than fully restoring the action points. As a result, it is possible to progress the game by consuming the required amount of action points in the current turn where the progression icon that extends into the next month is selected, without the user having to use a paid item, etc.

Thereafter, the control unit 110 consumes the action points by “10” (S506) and executes the game (S508). As a result, the supervisory levelis raised (S510), and the action points are fully restored to the maximum (S512). Thereafter, the control unit 110 reduces the action points borrowed in advance, i.e., the insufficient action points which are restored beforehand prior to the pre-borrowing process (S514). After S514, the process proceeds to step S122 in FIG. 21.

[5-4]

In the above, explanations have been given through the case where the consumption timing is set after the start of the training of the training target. However, it may be configured as follows.

As mentioned above, by providing a plurality of consumption timings between the start and the completion of the training, the total costs required for the training can be divided into smaller portions for each consumption timing, thereby reducing the amount of the first parameter required at each consumption timing. With this configuration, even when the training start timing is set to the consumption timing, the required amount of the first parameter at the start of the training can be reduced. Therefore, the plurality of consumption timings may be provided between the beginning (including the training start timing) and the completion of the training for the training target.

[5-5]

In the above, baseball game examples have been mainly described, but the present invention can be applied to other games as well. For example, the invention is applicable to various games regardless of the game format or genre, such as other sports games (games based on soccer, tennis, American football, basketball, ice hockey, volleyball, rugby, etc.), fighting games, combat games, digital card games, role-playing games, simulation games, and adventure games, as long as it is a “game in which a training target is trained by changing or setting parameters of the training target based on a user's operation”.

[5-6]

The game terminal 10 and the server 30 can communicate with each other to send and receive various data, and both are information processing apparatuses (computers) basically having the same hardware configuration equipped with a CPU, a ROM, a RAM, an auxiliary storage device, a communication unit, and the like. Therefore, some of the various functions described above may be realized by the CPU 11 of the game terminal 10, and the rest may be realized by the CPU 31 of the server 30. Alternatively, all the various functions described above may be realized by the CPU 11 of the game terminal 10. Similarly, all the various functions described above may be realized by the CPU 31 of the server 30.

[5-7]

Regarding the configuration having the storage control function for storing various types of information in a storage device, the storage device itself is not included in this configuration, and therefore may be provided anywhere, regardless of whether it is inside or outside the game system 1. For example, the storage device may be a storage device within the game system 1 (for example, the RAM 13, the auxiliary storage device 14, the RAM 33, the auxiliary storage device 34, the database DB, or the like), or the file server (online storage) configured separately from these.

[5-8]

A part or all the functions of the control unit 110 described above may be realized by an integrated circuit such as LSI (Large Scale Integration), etc. Further, it may be configured that each of the above functions is integrated into a processor individually. Alternatively, some or all the above-described functions may be integrated into a processor.

[5-9]

The computer-readable program of the present embodiment is stored in various types of computer-readable recording medium such as a hard disk, an optical disk (CD-ROM, DVD-ROM, etc.), a flexible disk, a semiconductor memory, or the like. The program is read out from the recording medium and executed by the CPU of a computer constituting the game system 1 or the game control apparatus. Further, a program can be provided to the computer via a network including a communication line such as the Internet, WAN, LAN, or a dedicated line. A program stored in a file server (online storage) may be read out by a computer. Further, a computer may receive a program delivered from a distribution server. The storage medium also includes a storage medium provided in or outside the distribution server, accessible from the distribution server for distributing a program. A program code stored on the storage medium of the distribution server may not be in a code form that can be directly executed on the computer that received the program. Namely, the format of the program stored in the storage medium of the distribution server is arbitrary, as far as it can be installed and executed on a computer after being downloaded from the distribution server. Further, the program may be divided when downloading, and a plurality of divided programs may be merged after being downloaded respectively at different timings. Further, the distribution server that distributes each of the divided programs may not be the same. Furthermore, a computer-readable recording medium also includes a medium that holds a program for a certain period, such as a volatile memory like RAM in a server that transmits the program via a network or a computer that receives it. The program may also be a differential program that can realize the above-described functions in combination with the program already stored in the computer.

### 6. Appendixes

From the above description, the present invention can be understood, for example, as follows. To clarify each aspect, reference numerals in the drawings are appended below in parentheses for convenience. However, the present invention is not limited to the drawings.
1) A program according to one aspect of the present invention causes a computer (1, 10, 30) that executes a control of a game for simulating training of a training target by changing or setting a parameter of the training target based on a user's operation, to function as:
a first parameter management unit (111) managing a first parameter (for example, action points) necessary for an execution of the game for training the training target, the first parameter being associated with the user identification information of the user; and
a game execution unit (112) executing the game for training the training target on a condition that a required amount of the first parameter is consumed at least at one consumption timing (for example, a turn that extends into the next month in-game time) set after a beginning of the training for the training target.

Here, for the “computer”, any computer including at least a processor and a storage device (memory) may be adopted. The processor is, for example, a CPU (Central Processing Unit). The processor may include a hardware such as a GPU (Graphics Processing Unit), a DSP (Digital Signal Processor), or an FPGA (Field Programmable Gate Array), etc., in addition to or instead of the CPU. For example, any of those including a processor and a storage device are included in the “computer”, such as a personal computer, a tablet computer, a smartphone, a stationary or portable game console, a commercial game console, a mobile phone terminal, a PHS terminal, a PDA, a multi-function television receiver with an information processing function, etc. Further, the “computer” may be composed of a plurality of devices capable of communication. For example, a system including a server and a terminal device is also included in the “computer”.
2) According to one aspect of the present invention, in the above aspect 1), on a condition that the first parameter of the required amount is consumed, the game execution unit (112) progresses the game for training the training target respectively at each of a plurality of consumption timings set from the beginning to a completion of the training of the training target.
3) According to one aspect of the present invention, in the above aspect 1) or 2), the training target is a group (for example, a baseball team) including a plurality of affiliated objects (for example, a plurality of players).
4) According to one aspect of the present invention, in the above aspect 3), the group includes a first affiliated object (for example, a scholarship student) selected by the user from among the owned objects associated with the user identification information, and a second affiliated object (for example, a general enrollment student) other than the owned objects.
5) According to one aspect of the present invention, in the above aspect 3) or 4), the training target is both the group (for example, a team) and individual affiliated objects included the group (for example, individual players in the team).
6) According to one aspect of the present invention, in the above aspect 5), the game execution unit (112) while accepting a batch instruction operation (for example, an operation of selecting the progress icon P46) for the training of the plurality of affiliated objects included in the group, accepts an individual instruction operation (for example, an operation of instructing an individual practice) for training each of the plurality of affiliated objects.
7) According to one aspect of the present invention, in any of the above aspects 3) to 6), the plurality of affiliated objects (a plurality of players in a high school baseball team) include affiliated objects (for example, 1^{st} year, 2^{nd} year, 3^{rd} year student players) remaining periods before the completion of the training of which are different.
8) According to one aspect of the present invention, in any of the above aspects 5) to 7), further causes the computer function as a group registration unit (113) that after a training of a group is complete, registers, in association with the user identification information, the group that can be used in a second game different from said game; and an object registration unit (114) that after a training of at least one of the plurality of affiliated objects is complete, registers, in association with the user identification information, the afliliated object that has completed the training as an object (for example, an individual player) that can be used in the second game.
9) According to one aspect of the present invention, in the above aspect 8), a timing of registering the group (for example, after a farewell party event) that has completed training by the group registration unit (113) is different from a timing of registering an individual affiliated object (for example, after a draft meeting event) that has completed training by the object registration unit (114).
10) According to one aspect of the present invention, in any of the above aspect 3) to 9), further causes the computer function as a management unit (115) that each time a training of the group including the plurality of affiliated objects is complete, excludes only some of the plurality of affiliated objects from the group, and adds new affiliated objects to the group, whereby it is possible to repetitively perform the training of the group while partially replacing the plurality of affiliated objects.
11) According to one aspect of the present invention, in the above aspect 10), further causes the computer function as a member candidate processing unit (116) that presents the user a plurality of candidate objects (for example, the scout player candidate P101) for new affiliated object before the new affiliated object joins to the group, and determines a probability that a candidate object selected by the user from among the plurality of candidate objects can be included in the new affiliated objects.
12) According to one aspect of the present invention, in any of the above aspects 1) to 11), the first parameter management unit (111) restores the first parameter (for example, action points) to an upper limit over time when the first parameter is consumed.
13) According to one aspect of the present invention, in any of the above aspects 1) to 12), further causes the computer function as a second parameter management unit (117) managing a second parameter (for example, the supervisory level) that can be improved as the game progresses by consuming the first parameter (for example, the action points), and a first parameter management unit (111) restoring the first parameter by a predetermined amount or to the upper limit when the second parameter is improved above the predetermined standard.
14) According to one aspect of the present invention, in the above aspect 13), further causes the computer function as the advance processing unit (118) that when it is determined that the second parameter will be improved above the predetermined standard if the game progresses by consuming the first parameter at the consumption timing, performs an advance processing of restoring the first parameter to the predetermined amount or the upper limit by improving the second parameter above the predetermined standard before consuming the first parameter at the consumption timing.
15) According to one aspect of the present invention, in any of the above aspect 14), if the first parameter, before the second parameter is improved by the advance processing unit (118), is insufficient for the required amount by an insufficient amount, the first parameter management unit (111) manages after the game processes, from the first parameter which has been restored by the advance processing unit (118), the insufficient amount is consumed.
16) A game control apparatus (10 and/or 30) according to one aspect of the present invention that executes a control of a game for training of a training target (for example, a plurality of team players) by changing or setting a parameter of the training target based on a user's operation, includes:
a first parameter management unit managing a first parameter (for example, action points) necessary for an execution of the game for training the training target, the first parameter being associated with the user identification information of the user; and
a game execution unit executing the game for training the training target on a condition that a required amount of the first parameter is consumed at least at one consumption timing (for example, in a turn that extends into the next month in-game time) set after a beginning of the training for the training target.

The game control apparatus of this configuration can be constituted by, for example, a computer as a game device (smartphone, mobile phone terminal, PHS, tablet computer, game dedicated machine, personal computer, multi-functional television receiver, commercial game machine, etc.). Alternatively, the game control apparatus can be configured by a computer such as a server that can communicate with the terminal device of each user. Alternatively, the game control apparatus may be configured by a plurality of computers (servers, terminal devices, etc.) that communicate with each other.
17) A game system (1) according to one aspect of the present invention including a server (30) and a terminal unit (10) capable of communicating with the server (30), that controls a game for training of a training target (for example, a plurality of team players) by changing or setting a parameter of the training target based on a user's operation, includes:
a first parameter management unit managing a first parameter (for example, action points) necessary for an execution of the game for training the training target, the first parameter being associated with the user identification information of the user; and
a game execution unit executing the game for training the training target on a condition that a required amount of the first parameter is consumed at least at one consumption timing (for example, in a turn that extends into the next month in-game time) set after a beginning of the training for the training target.
18) A control method of controlling the computer (1, 10, 30) in one aspect of the present invention which controls a game for training of a training target (for example, a plurality of team players) by changing or setting a parameter of the training target based on a user's operation, includes:
a first parameter management step (S112, S114) managing a first parameter (for example, action points) necessary for an execution of the game for training the training target, the first parameter being associated with the user identification information of the user; and
a game execution step (S114, S116) executing the game for training the training target on a condition that a required amount of the first parameter is consumed at least at one consumption timing (for example, in a turn that extends into the next month in-game time) set after a beginning of the training for the training target.
19) An information storage medium according to one aspect of the present invention is a non-transitory computer-readable storage medium storing the program in any of the above aspects 1) to 15).

Note that the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### DESCRIPTION OF REFERENCE SIGNS

1 . . . game system
N . . . network
DB . . . database
10 . . . game terminal
11 . . . CPU
13 . . . RAM
14 . . . auxiliary storage device
17 . . . display unit
30 . . . server
31 . . . CPU
33 . . . RAM
34 . . . auxiliary storage device
100 . . . data storage unit
110 . . . control unit
111 . . . first parameter management unit
112 . . . game execution unit
113 . . . group registration unit
114 . . . object registration unit
115 . . . management unit
116 . . . member candidate processing unit
117 . . . second parameter management unit
118 . . . advance processing unit
A43 . . . map
P44 . . . panel
P46 . . . progress icon
P47 . . . progress day information
A48 . . . practice participation player display area
48a . . . practice participating player
P101 . . . scout player candidates
TBL101 . . . panel information table
TBL102 . . . progress icon information table
TBL103 . . . user information table
TBL104 . . . character information table
DT105 . . . team data
DT106 . . . game progress data

What is claimed is:

1. A control method which controls a game for training a training target by changing or setting a parameter of the training target based on a user's operation, comprising:
managing a first parameter necessary for an execution of the game for training the training target, the first parameter being associated with a user identification information of the user; and
executing the game for training the training target on a condition that a required amount of the first parameter is consumed at least at one consumption timing set after a beginning of a training of the training target.

2. The control method of claim 1, wherein:
on a condition that the required amount of the first parameter is consumed, the game for training the training target is progressed respectively at each of a plurality of consumption timings set from the beginning to a completion of the training of the training target.

3. The control method of claim 1, wherein:
the training target is a group including a plurality of affiliated objects.

4. The control method of claim 3, wherein:
the group includes a first affiliated object selected by the user from among owned objects associated with the user identification information, and a second affiliated object other than the owned objects.

5. The control method of claim 3, wherein:
the training target includes both the group and each of the affiliated objects included in the group.

6. The control method of claim 5, further including:
accepting an individual instruction operation for training each of the plurality of affiliated objects while accepting a batch instruction operation for training of the plurality of affiliated objects included in the group.

7. The control method of claim 3, wherein:
the plurality of affiliated objects include affiliated objects remaining periods before the completion of the training of which are different.

8. The control method of claim 5, further including:
after a training of the group is complete, registering, in association with the user identification information, the group that has completed the training as a group that can be used in a second game different from said game; and
after a training of at least one of the plurality of affiliated objects is complete, registering, in association with the user identification information, the affiliated object that has completed the training as an object that can be used in the second game.

9. The control method of claim 8, wherein:
a timing of registering the group that has completed the training is different from a timing of registering the affiliated object that has completed the training.

10. The control method of claim 3, wherein:
each time a training of the group including the plurality of affiliated objects has been completed, only some of the plurality of affiliated objects are excluded from the group, and adding new affiliated objects to the group, so that the training of the group can be repetitively performed while partially replacing the plurality of affiliated objects.

11. The control method of claim 10, further including
before the new affiliated objects are jointed to the group, presenting the user a plurality of candidate objects for the new affiliated objects, and
determining a probability that a candidate object selected by the user from among the plurality of candidate objects can be included in the new affiliated objects.

12. The control method of claim 1, further including
when the first parameter is consumed, restoring the first parameter to an upper limit over time.

13. The control method of claim 1, further including:
managing a second parameter that may be improved as the game progresses by consuming the first parameter; and
when the second parameter is improved above a predetermined standard, restoring the first parameter by a predetermined amount or to an upper limit.

14. The control method of claim 13, further including:
when it is determined that the second parameter will be improved above the predetermined standard if the game progresses by consuming the first parameter at the consumption timing, performing an advance processing of restoring the first parameter to the predetermined amount or the upper limit by improving the second parameter above the predetermined standard before consuming the first parameter at the consumption timing.

15. The control method of claim 14, wherein:
if the first parameter, before the second parameter is improved by the advance processing, is insufficient for the required amount by an insufficient amount, after the game progresses, from the first parameter which has been restored by the advance processing, the insufficient amount is consumed.

16. A non-transitory computer-readable storage medium having recorded therein a program that is executed by a processor of an information processing apparatus and is for a control of a game for training a training target by changing or setting a parameter of the training target based on a user's operation, the program causing the processor to function as:
manage a first parameter necessary for an execution of the game for training the training target, the first parameter being associated with the user identification information of the user; and
execute the game for training the training target on a condition that a required amount of the first parameter is consumed at least at one consumption timing set after a beginning of a training of the training target.

17. The storage medium of claim 16, wherein:
the training target is a group including a plurality of affiliated objects; and
the plurality of affiliated objects include affiliated objects remaining periods before the completion of the training of which are different.

18. The storage medium of claim 16, wherein the program causes the processor to:
manage a second parameter that may be improved as the game progresses by consuming the first parameter;
when the second parameter is improved above a predetermined standard, restore the first parameter to a predetermined amount or to an upper limit; and
when it is determined that the second parameter will be improved above the predetermined standard if the game progresses by consuming the first parameter at the consumption timing, perform an advance processing of restoring the first parameter to the predetermined amount or the upper limit by improving the second parameter above the predetermined standard before consuming the first parameter at the consumption timing.

19. The storage medium of claim 18, wherein:
if the first parameter, before the second parameter is improved by the advance processing, is insufficient for the required amount by an insufficient amount, after the game progresses, from the first parameter which has been restored by the advance processing, the insufficient amount is consumed.

20. A game control apparatus including at least one processor, and a memory that cooperates with the processor and stores instructions to be executed by the processor, that controls a game for training a training target by changing or setting a parameter of the training target based on a user's operation, and that, when the instructions are executed by the processor, causing the processor to:
manage a first parameter necessary for an execution of the game for training the training target, the first parameter being associated with a user identification information of the user; and
execute the game for training the training target on a condition that a required amount of the first parameter is consumed at least at one consumption timing set after a beginning of a training of the training target.
